(19) United States
(12) Patent Application Publication
(10) Pub. No.: US 2018/0081236 A1
(43) Pub. Date: Mar. 22, 2018

(54) POLYMERIZABLE COMPOSITION, WAVELENGTH CONVERSION MEMBER, BACKLIGHT UNIT, AND LIQUID CRYSTAL DISPLAY DEVICE

(71) Applicant: FUJIFILM Corporation, Tokyo (JP)

(72) Inventors: Natsuru CHIKUSHI, Kanagawa (JP); Naoyoshi YAMADA, Kanagawa (JP); Kyohei ARAYAMA, Kanagawa (JP)

(73) Assignee: FUJIFILM Corporation, Tokyo (JP)

(21) Appl. No.: 15/822,763

(22) Filed: Nov. 27, 2017

Related U.S. Application Data
(63) Continuation of application No. PCT/JP2016/002401, filed on May 17, 2016.

(30) Foreign Application Priority Data
May 28, 2015 (JP) 2015-109095

(51) Int. Cl. G02F 1/1335; C09K 11/08; C08L 101/02

(52) U.S. Cl. CPC G02F 1/133514; G02F 1/133516; G02F 2001/01791; C08L 101/02; C09K 11/08

(57) ABSTRACT

A polymerizable composition includes a quantum dot, a monomer having an epoxy group or an oxetanyl group, and a polymer dispersant, in which the polymer dispersant is a compound represented by Formula I. In Formula I, A is an organic group having a coordinating group coordinated with a quantum dot, Z is an (n+m+l)-valent organic linking group, X¹ and X² are a single bond or a divalent organic linking group, R¹ represents an alkyl group, an alkenyl group, or an alkynyl group each of which may have a substituent, P is a polymer chain which has a polymerization degree of 3 or greater and which includes a polymer skeleton and of which the solubility parameter is 17 MPa^{1/2} to 22 MPa^{1/2}. n and m are each independently the number of 1 or greater, l is the number of 0 or greater, n+m+l is an integer of 2 to 10.

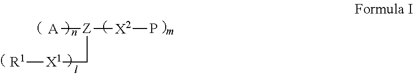

### CROSS-REFERENCE TO RELATED APPLICATION

This application is a Continuation of International Application No. PCT/JP2016/002401, filed May 17, 2016, which claims priority to Japanese Patent Application No. 2015-109095 filed May 28, 2015. Each of the above applications is hereby expressly incorporated by reference, in its entirety, into the present application.

### BACKGROUND OF THE INVENTION

### 1. Field of the Invention

The present invention relates to a polymerizable composition, a wavelength conversion member, a backlight unit, and a liquid crystal display device.

### 2. Description of the Related Art

The use of a flat panel display such as a liquid crystal display device (simply referred to as “LCD”) increases year by year as an image display device with low power consumption and space saving. The liquid crystal display device includes at least a backlight and a liquid crystal cell and generally further includes members such as a backlight side polarizing plate and a viewing side polarizing plate.

Recently, for the purpose of improving the color reproducibility of the LCD, a configuration including a wavelength conversion layer including quantum dots (also called QD) as a light emitting material in a wavelength conversion member of a backlight unit has attracted attention. The wavelength conversion member is a member that converts a wavelength of light incident from a light source and emits the light as white light, and the wavelength conversion layer that includes quantum dots as a light emitting material uses fluorescence that emits light due to two or three kinds of quantum dots having different emission properties, which are excited by the light incident from the light source and embodies white light.

Since the fluorescence due to the quantum dots has high brightness and small half-width, the LCD using quantum dots has excellent color reproducibility. With the progress of three-wavelength light source technology using such quantum dots, the color reproduction range of the LCD has increased from 72% to 100% of the National Television System Committee (NTSC) ratio.

The quantum dot has a problem in that, in a case where the quantum dot comes in contact with oxygen, the light emission efficiency decreases due to photooxidation reaction. In a case where the wavelength conversion member is processed into a product, for example, the wavelength conversion member is punched out by a punching tool, and the sheet-like wavelength conversion member raw material is cut out into the product size of the wavelength conversion member. In the product cut out in this manner, there is a concern in that the light emission efficiency of the quantum dots may decrease due to the permeation of oxygen from an end surface. In view of this, recently, in order to suppress the decrease in light emission efficiency of the quantum dots due to the permeation of oxygen from the interface end portion between an end surface and an adjacent layer, an epoxy curing resin having a low oxygen permeability has been used as a base material (matrix) of the wavelength conversion layer.

A ligand is coordinated on the surface of the quantum dots for the object of improving the affinity of a monomer or a solvent in the polymerizable composition with quantum dots or the light emission efficiency. A ligand may be contained in the composition including quantum dots in some cases. For example, in JP2007-181810A and JP2013-544018A, a polymerizable composition including quantum dots, an epoxy monomer, and a polymer dispersant is disclosed.

### SUMMARY OF THE INVENTION

However, the quantum dots had problems in that dispersion stability is extremely bad and quantum dots aggregate and precipitate in a composition including an epoxy monomer before curing. The aggregation and the precipitation of the quantum dots cause the decrease of the light emission efficiency. Various dispersing agents that can be applied in a case where an epoxy monomer is used have been proposed, but the dispersion stability is not sufficient and further improvement in the dispersion stability is required.

The present invention is conceived in view of the above circumstances and an object thereof is to provide a polymerizable composition in which dispersion stability of the quantum dots is satisfactory, satisfactory initial brightness of the wavelength conversion layer can be obtained, and brightness deterioration can be reduced.

Another object of the present invention is to provide a wavelength conversion member which have satisfactory initial brightness and in which the brightness deterioration is reduced, a backlight unit, and a liquid crystal display device.

A polymerizable composition according to the present invention comprises a quantum dot; a monomer having an epoxy group or an oxetanyl group; and a polymer dispersant, in which the polymer dispersant is a compound represented by Formula I.

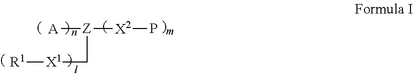

In Formula I, A is an organic group having a coordinating group coordinated with the quantum dot, Z is an (n+m+l)-valent organic linking group. X¹ and X² are a single bond or a divalent organic linking group, R¹ represents an alkyl group, an alkenyl group, or an alkynyl group each of which may have a substituent, P is a polymer chain which has a polymerization degree of 3 or greater and which includes at least one polymer skeleton selected from a polyacrylate skeleton, a polymethacrylate skeleton, a polyacrylamide skeleton, a polymethacrylamide skeleton, a polyester skeleton, a polyurethane skeleton, a polyurea skeleton, a polyamide skeleton, a polyether skeleton, a polyvinyl ether skeleton, and a polystyrene skeleton and of which a solubility parameter is 17 MPa^{1/2} to 22 MPa^{1/2}. n and m are each independently the number of 1 or greater, l is the number of 0 or greater, n+m+l is an integer of 2 to 10, n items of A's may be identical to or different from each other, m items of P's and X's may be identical to or different from each other, and 1 items of X¹'s and R¹'s may be identical to or different from each other.

It is preferable that the polymer chain P is represented by Formula P1.

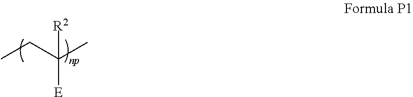

In Formula P1, E is a substituent including at least one of —O—, —CO—, —COO—, —COOR^{y}, an epoxy group, an oxetanyl group, an alicyclic epoxy group, an alkylene group, an alkyl group, and an alkenyl group, R^{y} is a hydrogen atom or an alkyl group having 1 to 6 carbon atoms. R² is a hydrogen atom or an alkyl group having 1 to 6 carbon atoms, np is the number of 3 to 500, and a plurality of E's and R²'s may be identical to or different from each other.

It is preferable that n and m are 1, l is 0, and the polymer dispersant is represented by Formula II.

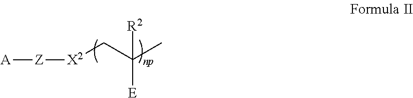

It is preferable that A is represented by Formula A1.

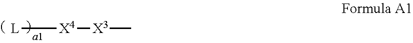

In Formula A1, X³ is a single bond or a divalent organic linking group, X⁴ is an (a1+1)-valent organic linking group. L is the coordinating group, a1 is an integer of 1 to 2.

Another polymerizable composition according to the present invention comprises a quantum dot; a monomer having an epoxy group or an oxetanyl group; and a polymer dispersant, in which the polymer dispersant is a compound represented by Formula III.

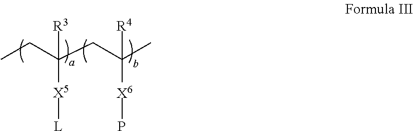

In Formula III, X⁵ and X⁶ are a single bond or a divalent organic linking group, R³ and R⁴ are a hydrogen atom or an alkyl group having 1 to 6 carbon atoms. L is a coordinating group coordinated with the quantum dot, P is a polymer chain which has a polymerization degree of 3 or greater and which includes at least one polymer skeleton selected from a polyacrylate skeleton, a polymethacrylate skeleton, a polyacrylamide skeleton, a polymethacrylamide skeleton, a polyester skeleton, a polyurethane skeleton, a polyurea skeleton, a polyamide skeleton, a polyether skeleton, a polyvinyl ether skeleton, and a polystyrene skeleton and of which a solubility parameter is 17 MPa^{1/2} to 22 MPa^{1/2}, a and b are each independently the number of 1 or greater, a+b is 2 to 1,000, a plurality of L's may be identical to or different from each other, and a plurality of P's may be identical to or different from each other.

It is preferable that the coordinating group is at least one selected from an amino group, a carboxy group, a mercapto group, a phosphine group, and a phosphine oxide group.

It is preferable that the monomer is an alicyclic epoxy compound.

The polymerizable composition according to the present invention may further comprise a photopolymerization initiator.

In the polymerizable composition according to the present invention, it is preferable that the quantum dot is at least one kind selected from a quantum dot having a center emission wavelength in a wavelength range of 600 nm to 680 nm, a quantum dot having a center emission wavelength in a wavelength range of 520 nm to 560 nm, and quantum dot having a center emission wavelength in a wavelength range of 430 nm to 480 nm.

A wavelength conversion member according to the present invention comprises a wavelength conversion layer obtained by curing the polymerizable composition according to the present invention.

The wavelength conversion member according to the present invention may further comprise a barrier film in which an oxygen permeability is 1.00 cm³/(m²·day·atm) or less, and at least one of two main surfaces of the wavelength conversion layer is in contact with the barrier film.

It is preferable that two of the barrier films are provided, and each of the two main surfaces of the wavelength conversion layer is in contact with the barrier films.

A backlight unit according to the present invention comprises at least the wavelength conversion member according to the present invention; and a light source.

A liquid crystal display device according to the present invention comprises at least the backlight unit according to the present invention and a liquid crystal cell.

The solubility parameter (SP value) of the polymer chain P is calculated, for example, by the method disclosed in J. Brandrup and E. H. Immergut, “Polymer Hanbook Third Edition”, John Wiley & Sons, 1989. D. W. Van Krevelen, “Properties of Polymers”, Elsevier, 1976, or Adhesion (Vol. 38, No. 6, page 10, 1994). According to the present invention, the desired effect can be obtained according to solubility parameters obtained by a calculation formula suggested by Toshinao Okitsu (Adhesion, Vol. 38, No. 6, page 10, 1994), and a solubility parameter (SP value) according to the present invention is a value obtained by this calculation formula.

The polymerizable composition according to the present invention is a polymerizable composition including a quantum dot; a monomer having an epoxy group or an oxetanyl group; and a polymer dispersant, and the polymer dispersant is a compound represented by Formula I. The polymer dispersant according to the present invention has a ligand group coordinated with the quantum dot, and thus the polymer dispersant is coordinated with the quantum dot in an satisfactory manner. The polymer chain of the polymer dispersant has a polymerization degree of 3 or greater and includes at least one polymer skeleton selected from a polyacrylate skeleton, a polymethacrylate skeleton, a polyacrylamide skeleton, a polymethacrylamide skeleton, a polyester skeleton, a polyurethane skeleton, a polyurea skeleton, a polyamide skeleton, a polyether skeleton, a polyvinyl ether skeleton, and a polystyrene skeleton and a solubility parameter thereof is 17 MPa^{1/2} to 22 MPa^{1/2}. Such a polymer chain is bulky and has steric repulsion. Therefore, the monomer having an epoxy group or an oxetanyl group can be interposed between adjacent polymer chains, and thus the quantum dot can be dispersed in the monomer in a satisfactory manner.

Another polymerizable composition of the present invention is a polymerizable composition including a quantum dot, a monomer having an epoxy group or an oxetanyl group, and a polymer dispersant, and the polymer dispersant is a compound represented by Formula III. The polymer dispersant has a coordinating group in a side chain of poly(meth)acrylate and includes a polymer chain which has a polymerization degree of 3 or greater and includes a polymer skeleton in a side chain of poly(meth)acrylate and of which a solubility parameter is 17 MPa^{1/2} to 22 MPa^{1/2}, and thus the quantum dot can be dispersed in the monomer in a satisfactory manner.

### BRIEF DESCRIPTION OF THE DRAWINGS

FIG. 1 is a schematic structural cross-sectional view of a wavelength conversion member according to an embodiment of the present invention.

FIG. 2 is a schematic structural view illustrating an example of a manufacturing device of the wavelength conversion member.

FIG. 3 is a partial enlarged view of the manufacturing device illustrated in FIG. 2.

FIG. 4 is a schematic structural cross-sectional view illustrating a backlight unit including the wavelength conversion member according to an embodiment of the present invention.

FIG. 5 is a schematic structural cross-sectional view of a liquid crystal display device including the backlight unit according to the present invention.

### DESCRIPTION OF THE PREFERRED EMBODIMENTS

Hereinafter, the embodiment according to the present invention is described with reference to the drawings. The description thereof is made based on a representative embodiment of the present invention, but the present invention is not limited to the embodiment.

In the present specification, a numerical range using “to” means a range including numerical values before and after “to” as a lower limit and an upper limit. In the present specification, a “half-width” of the peak refers to a width of a peak at a peak height of ½. Light having a center emission wavelength in a wavelength range of 430 to 480 nm is called blue light, light having a center emission wavelength in a wavelength range of 520 to 560 nm is called green light, and light having a center emission wavelength in a wavelength range of 600 to 680 nm is called red light. A “(meth)acryloyl group” means one or both of an acryloyl group and a methacryloyl group. “(Meth)acrylate” means one or both of acrylate and methacrylate.

[Polymerizable Composition]

Hereinafter, details of a polymerizable composition are described.

(Quantum Dot)

The quantum dots are semiconductor nanoparticles that emit fluorescence excited by excitation light. The polymerizable composition may contain two or more kinds of quantum dots having different emission characteristics as the quantum dots. In a case where blue light is used as the excitation light, the polymerizable composition can contain quantum dots that emit fluorescence (red light) L_{R} excited blue light L_{B}, and quantum dots that emit fluorescence (green light) L_{G} excited by the blue light L_{B}.

In a case where ultraviolet light is used as the excitation light, the polymerizable composition can contain quantum dots that emit fluorescence (red light) L_{R} excited by ultraviolet light L_{UV}, quantum dots that emit fluorescence (green light) L_{G} excited by the ultraviolet light L_{UV}, and quantum dots that emit fluorescence (blue light) L_{B} excited by the ultraviolet light L_{UV}.

Examples of the quantum dots that emit the red light L_{R} include light having a center emission wavelength in a wavelength range of 600 to 680 nm. Examples of the quantum dots that emit the green light L_{G} include light having a center emission wavelength in a wavelength range of 520 to 560 nm. Examples of the quantum dots that emit the blue light L_{B} include light having a center emission wavelength in a wavelength range of 430 to 480 nm.

As the quantum dots, paragraphs 0060 to 0066 of JP2012-169271A can be referred to, but the present invention is not limited to the disclosure of this document.

As the quantum dots, for example, core shell-type semiconductor nanoparticles are preferable, in view of durability improvement. As the core, Group II-VI semiconductor nanoparticles, Group III-V semiconductor nanoparticles, multi-element semiconductor nanoparticles, and the like can be used. Specific examples thereof include CdSe, CdTe, CdS, ZnS, ZnSe, ZnTe, InP, InAs, and InGaP, but the present invention is not limited thereto. Among these, CdSe, CdTe, InP, and InGaP are preferable, in view of emission of visible light with high efficiency. As the shell, CdS, ZnS, ZnO, GaAs, and a complex of these can be used, but the present invention is not limited thereto. An emission wavelength of the quantum dots can be generally adjusted by the composition and the size of the particles.

The quantum dots may be spherical particles, may be rod-like particles also called quantum rods, or may be tetrapod-type particles. In view of enlarging the color reproduction range of the liquid crystal display device by narrowing the light emission full width at half maximum (FWHM), spherical quantum dots or rod-shaped quantum dots (that is, quantum rods) are preferable.

A ligand having a Lewis basic coordinating group may be coordinated to the surfaces of the quantum dots in addition to the polymer dispersant of the present invention described below Quantum dots to which such a ligand is coordinated can be used in the polymerizable composition according to the present invention. Examples of the Lewis basic coordinating group include an amino group, a carboxy group, a mercapto group, a phosphine group, and a phosphine oxide group. Specific examples thereof include hexylamine, decylamine, hexadecylamine, octadecylamine, oleylamine, myristylamine, lauryl amine, oleic acid, mercaptopropionic acid, trioctylphosphine, and trioctylphosphine oxide. Among these, hexadecylamine, trioctylphosphine, and trioctylphosphine oxide are preferable, and trioctylphosphine oxide is particularly preferable.

The quantum dots to which these ligands are coordinated can be produced by a well-known synthesis method. For example, the synthesization can be performed in the method disclosed by the methods disclosed in C. B. Murray, D. J. Norris, M. G Bawendi, Journal American Chemical Society, 1993, 115 (19), pp 8706-8715 or The Journal Physical Chemistry, 101, pp 9463-9475, 1997. As the quantum dots to which the ligand is coordinated, commercially available products can be used without limitation. Examples thereof include Lumidot (manufactured by Sigma-Aldrich Co. LLC.).

In the polymerizable composition according to the present invention, the content of the quantum dots to which the ligand is coordinated is preferably 0.01 to 10 mass % and more preferably 0.05 to 5 mass % with respect to the total mass of the polymerizable compound included in the polymerizable composition.

The quantum dot according to the present invention may be added to the polymerizable composition in a state of particles, and may be added in a state of a dispersion liquid dispersed in a solvent. The addition in the state of the dispersion liquid is preferable, in view of suppression of aggregation of particles of quantum dots. The solvent used herein is not particularly limited thereto.

(Polymer Dispersant)

The polymer dispersant is a compound represented by Formula I.

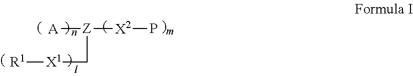

In Formula I, A is an organic group having a coordinating group that is coordinated to quantum dots, Z is an (n+m+l)-valent organic linking group, X¹ and X² are single bonds or divalent organic linking groups, R¹ represents an alkyl group, an alkenyl group, or an alkynyl group each of which may have a substituent, P is a polymer chain which has a polymerization degree of 3 or greater and which includes at least one polymer skeleton selected from a polyacrylate skeleton, a polymethacrylate skeleton, a polyacrylamide skeleton, a polymethacrylamide skeleton, a polyester skeleton, a polyurethane skeleton, a polyurea skeleton, a polyamide skeleton, a polyether skeleton, a polyvinyl ether skeleton, and a polystyrene skeleton and of which a solubility parameter is 17 MPa^{1/2} to 22 MPa^{1/2}. n and m are each independently the number of 1 or greater, l is the number of 0 or greater, and n+m+l is an integer of 2 to 10. n items of A's may be identical to or different from each other. m items of P's and X²'s are identical to or different from each other. 1 items of X¹'s and R¹'s are identical to or different from each other.

In Formula I, X¹ and X² represent a single bond or a divalent organic linking group. Examples of the divalent organic linking group include a group including 1 to 100 carbon atoms, 0 to 10 nitrogen atoms, 0 to 50 oxygen atoms, 1 to 200 hydrogen atoms, and 0 to 20 sulfur atoms, and may be unsubstituted or may be substituted.

The divalent organic linking group X¹ and X² are preferably a single bond or a divalent organic linking group including 1 to 50 carbon atoms, 0 to 8 nitrogen atoms, 0 to 25 oxygen atoms, 1 to 100 hydrogen atoms, and 0 to 10 sulfur atoms. A single bond or a divalent organic linking group including 1 to 30 carbon atoms, 0 to 6 nitrogen atoms, 0 to 15 oxygen atoms, 1 to 50 hydrogen atoms, and 0 to 7 sulfur atoms is more preferable. A single bond or a divalent organic linking group including 1 to 10 carbon atoms, 0 to 5 nitrogen atoms, 0 to 10 oxygen atoms, 1 to 30 hydrogen atoms, and 0 to 5 sulfur atoms is particularly preferable.

Specific examples of the divalent organic linking groups X¹ and X² include a group (may form a ring structure) obtained by combining the following structural units.

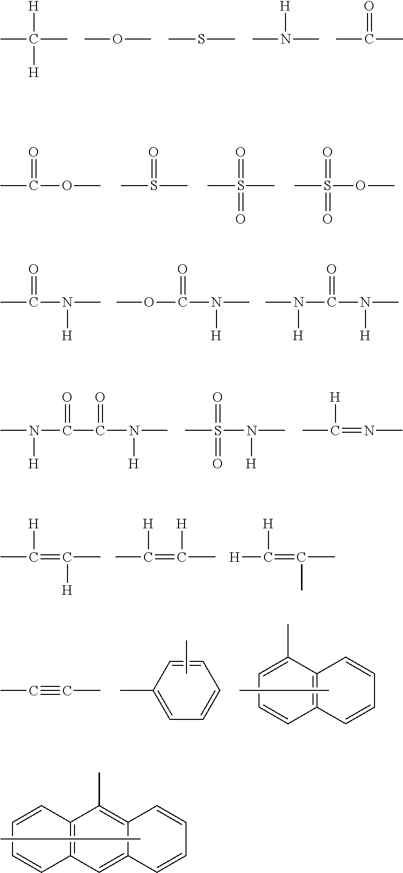

In a case where the divalent organic linking groups X¹ and X² have substituents, examples of the substituent include an alkyl group having 1 to 20 carbon atoms such as a methyl group and an ethyl group, an aryl group having 6 to 16 carbon atoms such as a phenyl group and a naphthyl group, an acyloxy group having 1 to 6 carbon atoms such as a hydroxyl group, an amino group, a carboxyl group, a sulfonamide group, an N-sulfonylamide group, and an acetoxy group, an alkoxy group having 1 to 6 carbon atoms such as a methoxy group and an ethoxy group, a halogen atom such as chlorine and bromine, an alkoxycarbonyl group having 2 to 7 carbon atoms such as a methoxycarbonyl group, an ethoxycarbonyl group, and a cyclohexyloxycarbonyl group, a cyano group, and a carbonate ester group such as t-butyl carbonate.

Examples of an (n+m+l)-valent organic linking group represented by Z include a group including 1 to 100 carbon atoms, 0 to 10 nitrogen atoms, 0 to 50 oxygen atoms, 1 to 200 hydrogen atoms, and 0 to 20 sulfur atoms, and the (n+m+l)-valent organic linking group may be unsubstituted or may be substituted.

The (n+m+l)-valent organic linking group Z is preferably a group including 1 to 60 carbon atoms, 0 to 10 nitrogen atoms, 0 to 40 oxygen atoms, 1 to 120 hydrogen atoms, and 0 to 10 sulfur atoms, more preferably a group including 1 to 50 carbon atoms, 0 to 10 nitrogen atoms, 0 to 30 oxygen atoms, 1 to 100 hydrogen atoms, and 0 to 7 sulfur atoms, and particularly preferably a group including 1 to 40 carbon atoms, 0 to 8 nitrogen atoms, 0 to 20 oxygen atoms, 1 to 80 hydrogen atoms, and 0 to 5 sulfur atoms.

Examples of the (n+m+l)-valent organic linking group Z include the following structural unit or a group (may form a ring structure) obtained by combining the following structural units.

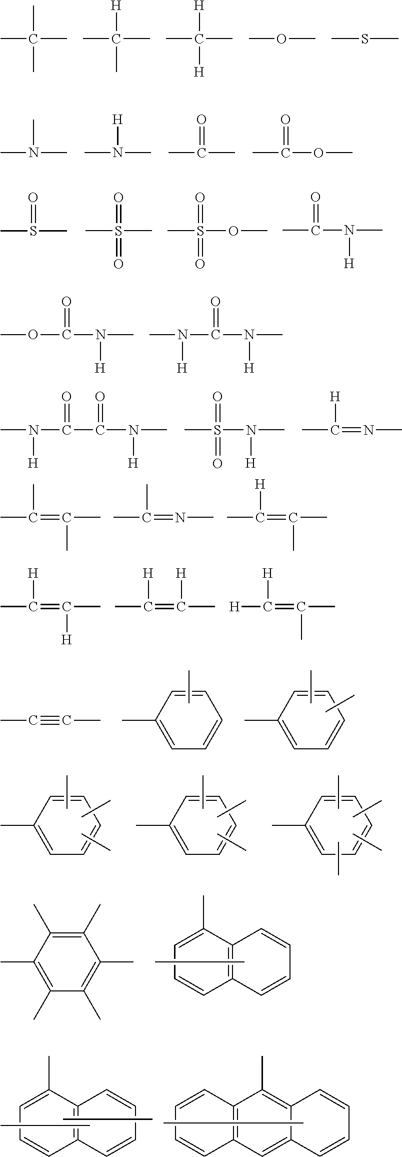

Specific Examples (1) to (20) of the (n+m+l)-valent organic linking group Z are provided below. Here, the present invention is not limited to these. * in the organic linking group indicates a position that is bonded to A, X¹, and X² in Formula I.

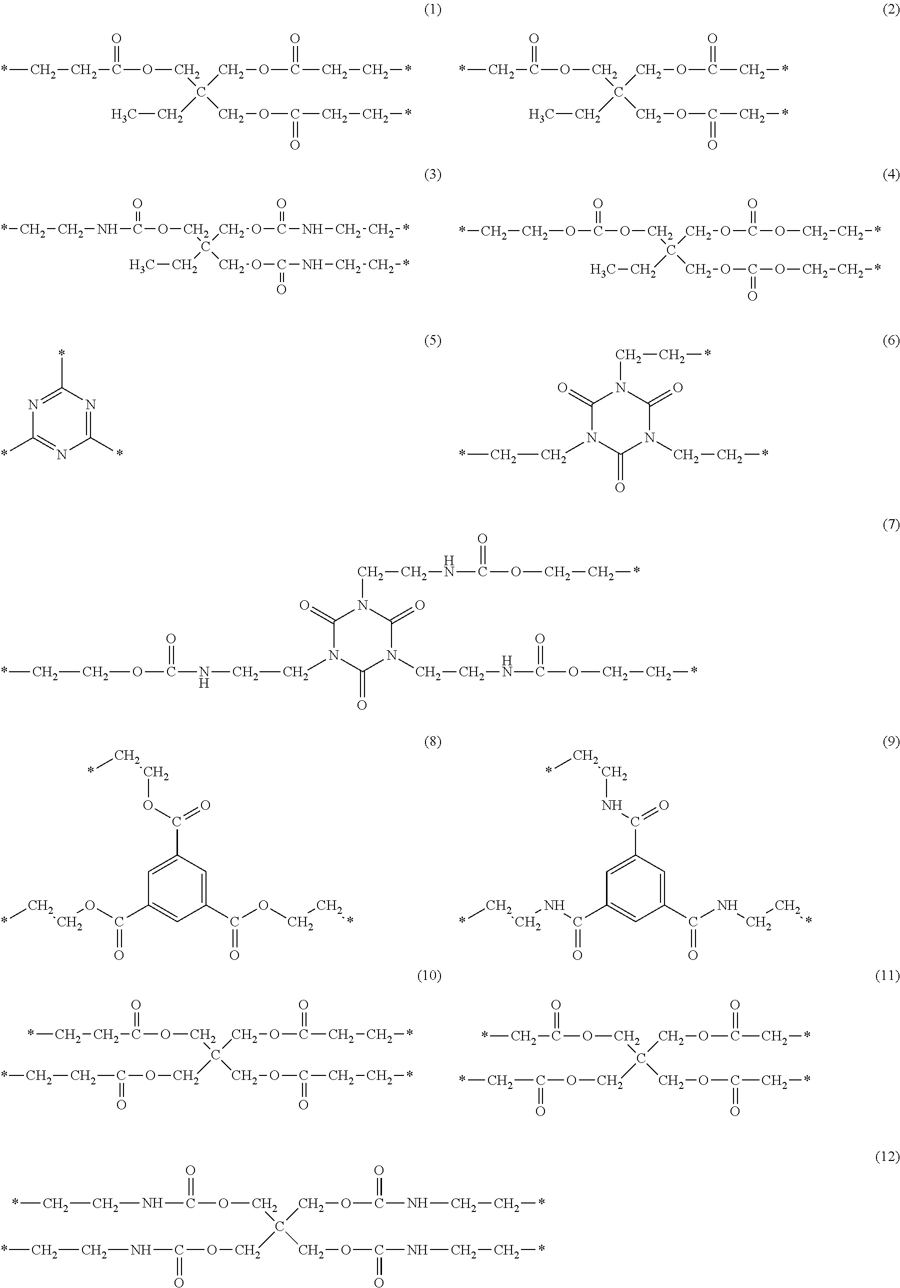

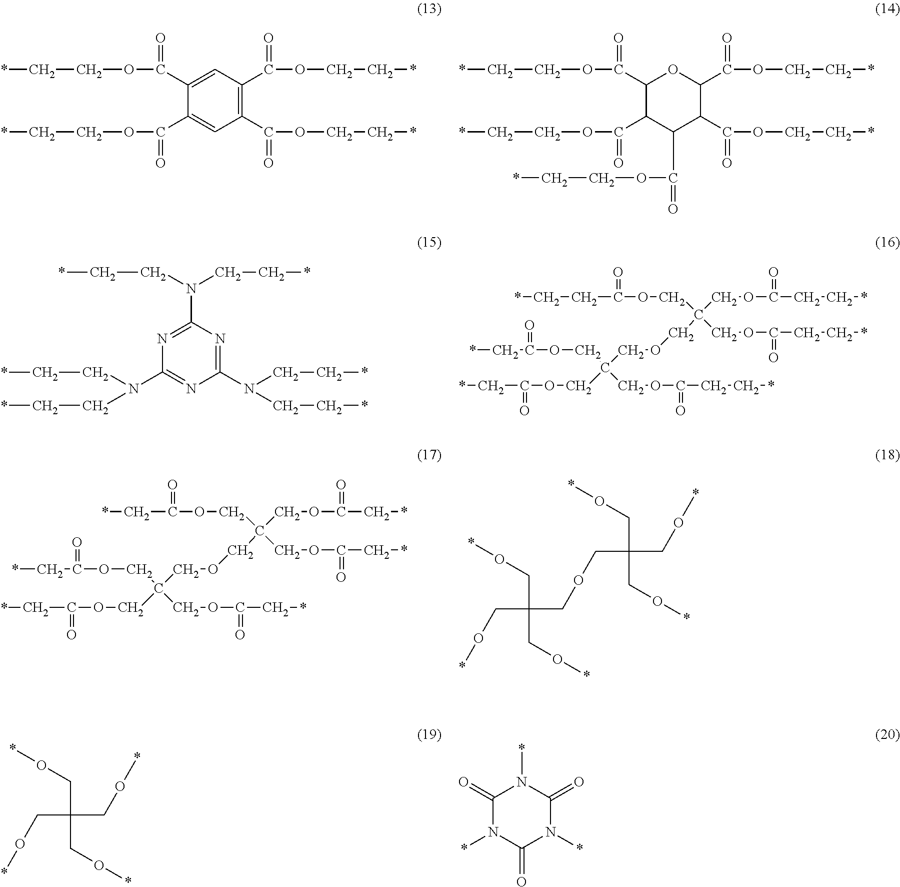

In a case where the (n+m+l)-valent organic linking group Z has a substituent, examples of the substituent include an alkyl group having 1 to 20 carbon atoms such as a methyl group and an ethyl group, an aryl group having 6 to 16 carbon atoms such as a phenyl group and a naphthyl group, an acyloxy group having 1 to 6 carbon atoms such as a hydroxyl group, an amino group, a carboxyl group, a sulfonamide group, an N-sulfonylamide group, and an acetoxy group, an alkoxy group having 1 to 6 carbon atoms such as a methoxy group and an ethoxy group, a halogen atom such as chlorine and bromine, an alkoxycarbonyl group having 2 to 7 carbon atoms such as a methoxycarbonyl group, an ethoxycarbonyl group, and a cyclohexyloxycarbonyl group, a cyano group, and a carbonate ester group such as t-butyl carbonate.

Among the specific examples, in view of availability of raw materials, easiness of synthesis, monomers, and solubility in various solvents, the (n+m+l)-valent organic linking group Z is most preferably the following groups.

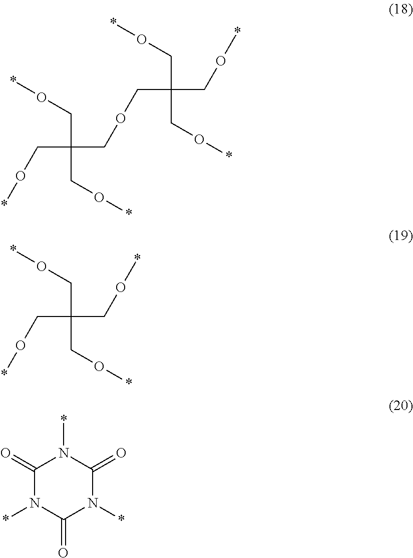

In Formula I, R¹ is an alkyl group, an alkenyl group, or an alkynyl group each of which may have a substituent. The number of carbon atoms is preferably 1 to 30 and more preferably 1 to 20 carbon atoms. As the substituent, examples of the substituent include an alkyl group having 1 to 20 carbon atoms such as a methyl group and an ethyl group, an aryl group having 6 to 16 carbon atoms such as a phenyl group and a naphthyl group, an acyloxy group having 1 to 6 carbon atoms such as a hydroxyl group, an amino group, a carboxyl group, a sulfonamide group, an N-sulfonylamide group, and an acetoxy group, an alkoxy group having 1 to 6 carbon atoms such as a methoxy group and an ethoxy group, a halogen atom such as chlorine and bromine, an alkoxycarbonyl group having 2 to 7 carbon atoms such as a methoxycarbonyl group, an ethoxycarbonyl group, and a cyclohexyloxycarbonyl group, a cyano group, and a carbonate ester group such as t-butyl carbonate.

A polymer chain P according to the present invention includes at least one polymer skeleton selected from a polyacrylate skeleton, a polymethacrylate skeleton, a polyacrylamide skeleton, a polymethacrylamide skeleton, a polyester skeleton, a polyurethane skeleton, a polyurea skeleton, a polyamide skeleton, a polyether skeleton, a polyvinyl ether skeleton, and a polystyrene skeleton in which a polymerization degree is 3 or greater and has a meaning of including a polymer, a modified product, or a copolymer having these polymer skeletons. Examples thereof include a polyether/polyurethane copolymer, and a copolymer of a polyether/vinyl monomer. The polymer chain may be any one of a random copolymer, a block copolymer, and a graft copolymer. Among these, a polymer or a copolymer consisting of a polyacrylate skeleton is particularly preferable.

The polymer chain P is preferably soluble in the solvent. If the affinity to the solvent is low, for example, in a case where the polymer chain P is used as a ligand, affinity to a dispersion medium is weak, and an adsorption layer sufficient for dispersion stabilization may not be secured.

The monomer that forms the polymer chain P is not particularly limited, and (meth)acrylic acid esters, crotonic acid esters, vinyl esters, maleic acid diesters, fumaric acid diesters, itaconic acid diesters, aliphatic polyester, (meth)acrylamides, aliphatic polyamide styrenes, vinyl ethers, vinyl ketones, olefins, maleimides, (meth)acrylonitrile, a monomer having an acidic group, and the like are preferable.

Hereinafter, preferable examples of these monomers are described below.

Examples of (meth)acrylic acid esters include methyl (meth)acrylate, ethyl (meth)acrylate, n-propyl (meth)acrylate, isopropyl (meth)acrylate, n-butyl (meth)acrylate, isobutyl (meth)acrylate, t-butyl (meth)acrylate, amyl (meth)acrylate, n-hexyl (meth)acrylate, cyclohexyl (meth)acrylate, t-butyl cyclohexyl (meth)acrylate, 2-ethylhexyl (meth)acrylate, t-octyl (meth)acrylate, dodecyl (meth)acrylate, octadecyl (meth)acrylate, acetoxyethyl (meth)acrylate, phenyl (meth)acrylate, 2-hydroxyethyl (meth)acrylate, 2-hydroxypropyl (meth)acrylate, 3-hydroxypropyl (meth)acrylate, 4-hydroxybutyl (meth)acrylate, 2-methoxyethyl (meth)acrylate, 2-ethoxyethyl (meth)acrylate, 2-(2-methoxyethoxy)ethyl (meth)acrylate, 3-phenoxy-2-hydroxypropyl (meth)acrylate, 2-chloroethyl (meth)acrylate, glycidyl (meth)acrylate, 3,4-epoxycyclohexylmethyl (meth)acrylate, vinyl (meth)acrylate, 2-phenylvinyl (meth)acrylate, 1-propenyl (meth)acrylate, allyl (meth)acrylate, 2-allyloxyethyl (meth)acrylate, propargyl (meth)acrylate, benzyl (meth)acrylate, diethylene glycol monomethyl ether (meth)acrylate, diethylene glycol monoethyl ether (meth)acrylate, triethylene glycol monomethyl ether (meth)acrylate, triethylene glycol monoethyl ether (meth)acrylate, polyethylene glycol monomethyl ether (meth)acrylate, polyethylene glycol monoethyl ether (meth)acrylate, β-phenoxyethoxyethyl (meth)acrylate, nonylphenoxypolyethylene glycol (meth)acrylate, dicyclopentenyl (meth)acrylate, dicyclopentenyloxyethyl (meth)acrylate, trifluoroethyl (meth)acrylate, octafluoropentyl (meth)acrylate, perfluorooctylethyl (meth)acrylate, dicyclopentanyl (meth)acrylate, tribromophenyl (meth)acrylate, tribromophenyloxyethyl (meth)acrylate, and γ-butyrolactone (meth)acrylate.

Examples of crotonic acid esters include butyl crotonate and hexyl crotonate.
Examples of vinyl esters include vinyl acetate, vinyl chloroacetate, vinyl propionate, vinyl butyrate, vinyl methoxyacetate, and vinyl benzoate.
Examples of maleic acid diesters include dimethyl maleate, diethyl maleate, and dibutyl maleate.
Examples of fumaric acid diesters include dimethyl fumarate, diethyl fumarate, and dibutyl fumarate.
Examples of itaconic acid diesters include dimethyl itaconate, diethyl itaconate, and dibutyl itaconate.

Examples of aliphatic polyesters include polycaprolactone and polyvalerolactone.
Examples of the (meth)acrylamides include (meth)acrylamide, N-methyl (meth)acrylamide, N-ethyl (meth)acrylamide, N-propyl (meth)acrylamide, N-isopropyl (meth)acrylamide, N-n-butyl acrylic (meth)amide, N-t-butyl (meth)acrylamide, N-cyclohexyl (meth)acrylamide, N-(2-methoxyethyl) (meth)acrylamide. N,N-dimethyl (meth)acrylamide, N,N-diethyl (meth)acrylamide, N-phenyl (meth)acrylamide. N-nitrophenyl acrylamide, N-ethyl-N-phenylacrylamide, N-benzyl (meth)acrylamide, (meth)acryloyl morpholine, diacetone acrylamide, N-methylol acrylamide, N-hydroxyethyl acrylamide, vinyl (meth)acrylamide. N,N-diallyl (meth)acrylamide, and N-allyl (meth)acrylamide.

Examples of aliphatic polyamides include polycaprolactam and polyvalerolactam.
Examples of styrenes include styrene, methyl styrene, dimethyl styrene, trimethylstyrene, ethyl styrene, isopropyl styrene, butyl styrene, hydroxystyrene, methoxystyrene, butoxystyrene, acetoxystyrene, chlorostyrene, dichlorostyrene, bromostyrene, chloromethyl styrene, hydroxystyrene protected with a group (for example, t-Boc) that can be deprotected with an acidic substance, methyl vinyl benzoate, and α-methylstyrene.
Examples of vinyl ethers include methyl vinyl ether, ethyl vinyl ether, 2-chloroethyl vinyl ether, hydroxyethyl vinyl ether, propyl vinyl ether, butyl vinyl ether, hexyl vinyl ether, octyl vinyl ether, methoxyethyl vinyl ether, and phenyl vinyl ether.

Examples of vinyl ketones include methyl vinyl ketone, ethyl vinyl ketone, propyl vinyl ketone, and phenyl vinyl ketone.
Examples of olefins include ethylene, propylene, isobutylene, butadiene, and isoprene.
Examples of maleimides include maleimide, butylmaleimide, cyclohexylmaleimide, and phenylmaleimide.

(Meth)acrylonitrile, a heterocyclic group substituted with a vinyl group (for example, vinylpyridine, N-vinylpyrrolidone, and vinylcarbazole), N-vinylformamide, N-vinylacetamide, N-vinylimidazole, vinylcaprolactone, and the like can be used.

The polymer chain P is more preferably a group represented by Formula P1.

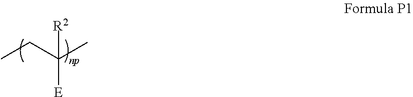

In Formula P1, E is a substituent including at least one of —O—, —CO—, —COO—, —COOR^{y}, an epoxy group, an oxetanyl group, an alicyclic epoxy group, an alkylene group, an alkyl group, and an alkenyl group. R^{y} is a hydrogen atom or an alkyl group having 1 to 6 carbon atoms, R² is a hydrogen atom or an alkyl group having 1 to 6 carbon atoms. np is the number of 3 to 500. A plurality of E's and R²'s may be identical to or different from each other.

Examples of the polymer chain represented by Formula P1 include the followings.

np is preferably 3 to 500, more preferably 4 to 200, and even more preferably 5 to 100. The polymer chain P has a solubility parameter of 19.5 MPa^{1/2} to 21.82 MPa^{1/2}.

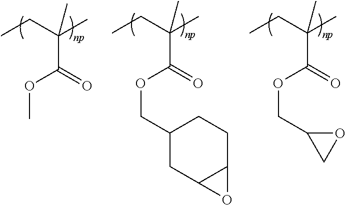

In Formula I, the polymer dispersant may be a compound represented by Formula II in which n and m are 1, and l is 0.

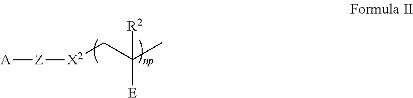

A is preferably a group represented by Formula A1.

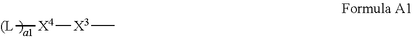

In Formula A1, X³ is a single bond or a divalent organic linking group, X⁴ is an (a1+1)-valent organic linking group, L is a coordinating group, a1 is an integer of 1 to 2. X³ is the same as X² in Formula I, and the preferable range is also the same.

The (a1+1)-valent organic linking group X⁴ is preferably a group including 1 to 60 carbon atoms, 0 to 10 nitrogen atoms, 0 to 40 oxygen atoms, 1 to 120 hydrogen atoms, and 0 to 10 sulfur atoms, more preferably a group including 1 to 50 carbon atoms, 0 to 10 nitrogen atoms, 0 to 30 oxygen atoms, 1 to 100 hydrogen atoms, and 0 to 7 sulfur atoms, and particularly preferably a group including 1 to 40 carbon atoms, 0 to 8 nitrogen atoms, 0 to 20 oxygen atoms, 1 to 80 hydrogen atoms, and 0 to 5 sulfur atoms.

Specific examples of the (a1+1)-valent organic linking group X⁴ include the following structural units and a group (may form a ring structure) obtained by combining the structural units.

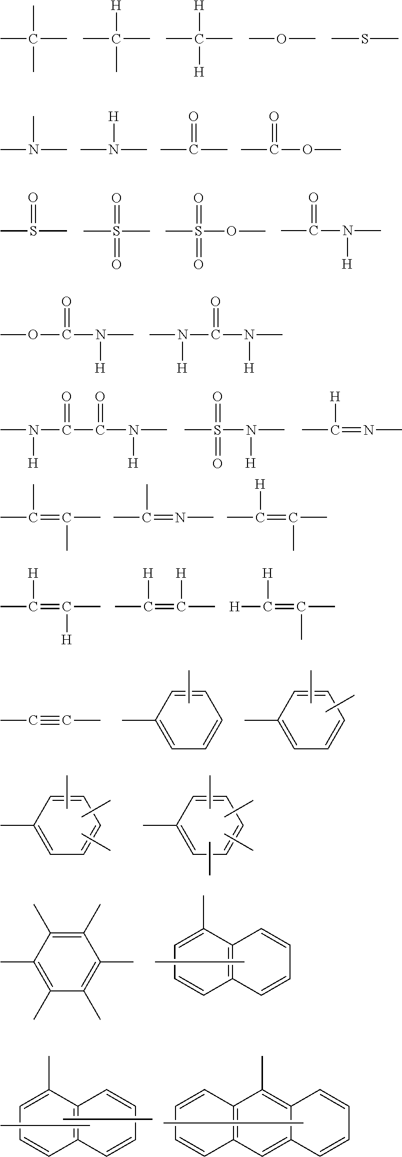

In a case where the (a1+1)-valent organic linking group X⁴ has a substituent, examples of the substituent include an alkyl group having 1 to 20 carbon atoms such as a methyl group and an ethyl group, an aryl group having 6 to 16 carbon atoms such as a phenyl group and a naphthyl group, an acyloxy group having 1 to 6 carbon atoms such as a hydroxyl group, an amino group, a carboxyl group, a sulfonamide group, an N-sulfonylamide group, and an acetoxy group, an alkoxy group having 1 to 6 carbon atoms such as a methoxy group and an ethoxy group, a halogen atom such as chlorine and bromine, an alkoxycarbonyl group having 2 to 7 carbon atoms such as a methoxycarbonyl group, an ethoxycarbonyl group, and a cyclohexyloxycarbonyl group, and a cyano group, and a carbonate ester group such as t-butyl carbonate.

The coordinating group L is preferably at least one selected from an amino group, a carboxy group, a mercapto group, a phosphine group, and a phosphine oxide group. Among these, a carboxy group and a phosphine oxide group are even more preferable.

In Formula A1, a group including the coordinating group L and the divalent organic linking group X⁴ is preferably the followings. * in the following groups indicates a position that is bonded to X³.

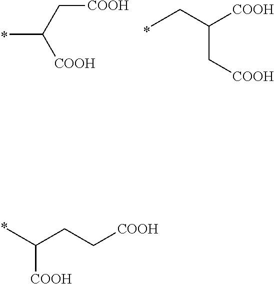

The length of X⁴ is shorter than about 1 nm, and has a plurality of coordinating groups in the range of the length. Therefore, since the ligands can perform multipoint adsorption in a state in which quantum dots are denser, the ligands are strongly coordinated. Since the quantum dots cover the surfaces of the quantum dots without being deviated from the ligands, the generation of a surface level on surfaces of the quantum dots, the oxidation of quantum dots, and the aggregation of quantum dots are suppressed, and the decrease of the light emission efficiency can be suppressed. Even in a case where the ligand is already coordinated with the quantum dots, the polymer dispersant according to the present invention can enter the gaps of the ligands, and the decrease of the light emission efficiency of the quantum dots can be suppressed.

The polymer dispersant may be a compound represented by Formula III.

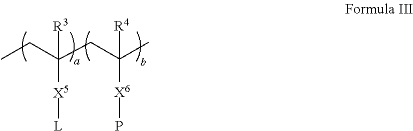

In Formula III, X⁵ and X⁶ each are a single bond or a divalent organic linking group, R³ and R⁴ each are a hydrogen atom or an alkyl group having 1 to 6 carbon atoms, P is a polymer chain which has a polymerization degree of 3 or greater and which includes at least one polymer skeleton selected from a polyacrylate skeleton, a polymethacrylate skeleton, a polyacrylamide skeleton, a polymethacrylamide skeleton, a polyester skeleton, a polyurethane skeleton, a polyurea skeleton, a polyamide skeleton, a polyether skeleton, a polyvinyl ether skeleton, and a polystyrene skeleton and of which the solubility parameter is 17 MPa^{1/2} to 22 MPa^{1/2}. a and b are each independently the number of 1 or greater, and a+b is 2 to 1,000. A plurality of L's may be identical to or different from each other. A plurality of P's may be identical to or different from each other.

X⁵ and X⁶ each are a single bond or a divalent organic linking group. X⁵ and X⁶ as the divalent organic linking group have the same meaning as the divalent organic linking group X² in Formula I. Particularly, a group including —COO—, —CONH—, —O—, and the like is preferable in view of easiness of material acquisition and synthesis.

R³ and R⁴ each are an alkyl group having 1 to 6 carbon atoms, and is preferably a hydrogen atom or a methyl group.

As the polymer chain P in Formula III, the followings are preferable.

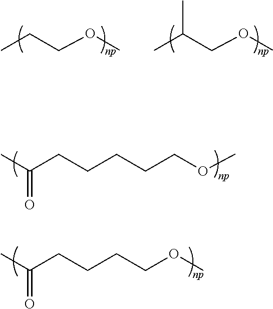

In the polymer chain P, np is preferably 3 to 300, more preferably 4 to 200, and even more preferably 5 to 100. The solubility parameter of the polymer chain P is 17.96 MPa^{1/2} to 20.62 MPa^{1/2}.

Specific Examples of the polymer dispersant represented by Formula III include the followings.

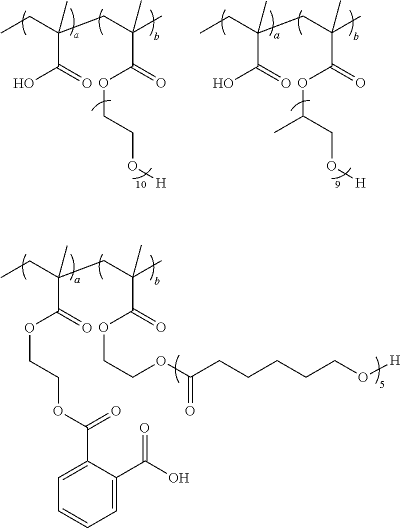

a:b of the polymer dispersant is preferably 1:9 to 7:3 and more preferably 2:8 to 5:5.

The molecular weight of the polymer dispersant according to the present invention is preferably 2,000 to 100,000, more preferably 3,000 to 50,000, and particularly preferably 5,000 to 30,000 by the weight-average molecular weight. In a case where the weight-average molecular weight is in this range, the quantum dots can be dispersed in a monomer having an epoxy group or an oxetanyl group in a satisfactory manner.

(Synthesis of Polymer Dispersant)

The ligands of Formulae I and II in a quantum dot containing composition according to the present invention can be synthesized in the well-known synthesis methods. For example, in the method disclosed in JP2007-277514A, the ligands can be synthesized by substituting organic coloring agent moieties with coordinating moieties.

The polymer dispersant of Formula III can be synthesized by copolymerization of a corresponding monomer and polymer reaction to a precursor polymer. Examples of the monomer having a steric repulsive group in a side chain include commercially available products such as BLEMMER AE-400 (NOF Corporation) and BLENMER AP-800 (NOF Corporation).

(Monomer)

The monomer in the polymerizable composition according to the present invention has an epoxy group or an oxetanyl group.

As the monomer having an epoxy group or an oxetanyl group, an aliphatic cyclic epoxy compound, bisphenol A diglycidyl ether, bisphenol F diglycidyl ether, bisphenol S diglycidyl ether, brominated bisphenol A diglycidyl ether, brominated bisphenol F diglycidyl ether, brominated bisphenol S diglycidyl ether, hydrogenated bisphenol A diglycidyl ether, hydrogenated bisphenol F diglycidyl ether, hydrogenated bisphenol S diglycidyl ether, 14-butanediol diglycidyl ether, 1,6-hexanediol diglycidyl ether, glycerin triglycidyl ether, trimethylolpropane triglycidyl ether, polyethylene glycol diglycidyl ether, polypropylene glycol diglycidyl ethers; polyglycidyl ethers of polyether polyols obtained by adding one or more alkylene oxides to aliphatic polyhydric alcohols such as ethylene glycol, propylene glycol, and glycerin; diglycidyl esters of aliphatic long chain dibasic acids; glycidyl esters of higher fatty acids; and a compound containing epoxycycloalkane are suitably used in the present invention.

Examples of the commercially available products that are suitably used as the monomer having an epoxy group or an oxetanyl group include CELLOXIDE (registered trademark) 2021P and CELLOXIDE (registered trademark) 8000 of Daicel Corporation, and 4-vinylcyclohexene dioxide manufactured by Sigma-Aldrich Co., LLC. These may be used singly or two or more kinds thereof may be used in combination.

A method of manufacturing the monomer having an epoxy group or an oxetanyl group is not particularly limited, and, for example, can be synthesized with reference to “Fourth Edition of Experimental Chemistry Lessons, 20 Organic Syntheses II”, Maruzen K. K. Press, pages 213˜, 1992; Ed. by Alred Hasfner, “The chemistry of heterocyclic compounds-Small Ring Heterocycles Part 3. Oxiranes”, John Wiley & Sons, An Interscience Publication, New York, 1985; Yoshimura, ADHESIVES, Book 29, No. 12, 32, 1985, Yoshimura, ADHESIVES, Vol. 30, No. 5, 42, 1986, Yoshimura, ADHESIVES, Vol. 30. No. 7, 42, 1986, JP1999-100378A (JP-H11-100378A), JP2906245B, and JP2926262B.

—Alicyclic Epoxy Compound—

The polymerizable compound may be an alicyclic epoxy compound. The alicyclic epoxy compound may be used singly or two or more types having different structures may be used. Hereinafter, the content relating to an alicyclic epoxy compound refers to a total content in a case where two or more kinds of alicyclic epoxy compounds having different structures are used. The same is applied to other components in a case where two or more kinds having different structures are used. The alicyclic epoxy compound has satisfactory curing properties due to light irradiation compared with an aliphatic epoxy compound. It is advantageous to use a polymerizable compound having excellent photocuring properties in view of forming a layer having uniform physical properties on the light irradiated side and a non-irradiated side, in addition to the improvement of the productivity. Accordingly, it is also possible to suppress the curling of the wavelength conversion layer and to provide a wavelength conversion member of uniform qualities. In general, the epoxy compound tends to have less curing contraction in a case of photocuring. This point is advantageous in forming a wavelength conversion layer having less deformation and a smooth surface.

The alicyclic epoxy compound has at least one alicyclic epoxy group. Here, an alicyclic epoxy group refers to a monovalent substituent having a condensed ring of an epoxy ring and a saturated hydrocarbon ring, and preferably is a monovalent substituent having a condensed ring of an epoxy ring and a cycloalkane ring. Examples of a more preferable alicyclic epoxy compound include an alicyclic epoxy compound having one or more of the following structures in which an epoxy ring and a cyclohexane ring are condensed in one molecule.

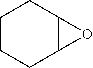

Two or more structures may be included in one molecule, and it is preferable that one or two structures are included in one molecule. The structure may have one or more substituents. Examples of the substituent include an alkyl group, a hydroxyl group, an alkoxy group, a halogen atom, a cyano group, an amino group, a nitro group, an acyl group, and a carboxyl group. Examples of the alkyl group include an alkyl group having 1 to 6 carbon atoms. Examples of the alkoxy group include an alkoxy group having 1 to 6 carbon atoms. Examples of the halogen atom include a fluorine atom, a chlorine atom, or a bromine atom.

The alicyclic epoxy compound may have a polymerizable functional group other than an alicyclic epoxy group. The polymerizable functional group refers to a functional group that can perform a polymerization reaction by radical polymerization or anionic polymerization, and examples thereof include a (meth)acryloyl group.

Examples of the commercially available products that can be suitably used as an alicyclic epoxy compound include CELLOXIDE (registered trademark) 2000, CELLOXIDE (registered trademark) 2021P, CELLOXIDE (registered trademark) 3000, CELLOXIDE (registered trademark) 8000, CYCLOMER (registered trademark) M100, EPOLEAD (registered trademark) GT301, EPOLEAD (registered trademark) GT401 manufactured by Daicel Corporation, 4-vinylcyclohexene dioxide manufactured by Sigma-Aldrich Co., LLC, D-limonene oxide of Nippon Terpene Chemicals, Inc., and SANSOSIZER (registered trademark) E-PS of New Japan Chemical Co., Ltd. These may be used singly or two or more kinds thereof may be used in combination. Among these, in view of improvement of the adhesiveness between a wavelength conversion layer and an adjacent layer, the following alicyclic epoxy compound is particularly preferable. The alicyclic epoxy compound can be obtained as CELLOXIDE (registered trademark) 2021P (CEL2021P) of Daicel Corporation as a commercially available product. The alicyclic epoxy compound can be obtained as CYCLOMER (registered trademark) M100 of Daicel Corporation as a commercially available product. Structural formulae of CELLOXIDE (registered trademark) 2021P and CYCLOMER (registered trademark) M100 are provided below.

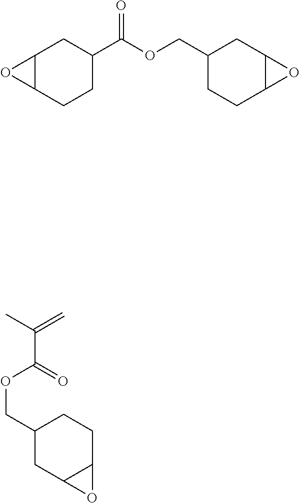 [SMILES: O=C(OCC1CCC2OC2C1)C1CCC2OC2C1 ; C=C(C)C(=O)OCC1CCC2OC2C1]

The alicyclic epoxy compound can be manufactured by a well-known synthesis method. As the following synthesis method, synthesis can be performed with reference to the documents as in the case of the above monomer having an epoxy group or an oxetanyl group.

(Polymerizable Compound that can be Combined with Alicyclic Epoxy Compound)

In addition to one or more kinds of the alicyclic epoxy compounds, the polymerizable compound may contain one or more kinds of other polymerizable compounds may be included. The other polymerizable compounds are preferably a (meth)acrylate compound such as a monofunctional (meth)acrylate compound and a polyfunctional (meth)acrylate compound. Here, in the present invention and the present specification, a (meth)acrylate compound or (meth)acrylate refers to a compound including one or more (meth)acryloyl groups in one molecule, and the (meth)acryloyl group is used to indicate one or both of an acryloyl group and a methallyloyl group. With respect to the (meth)acrylate compound, the expression “monofunctional” means that the number of (meth)acryloyl groups contained in one molecule is one, and the expression “polyfunctional” means that the number of (meth)acryloyl groups included in one molecule is two or greater.

The content of the (meth)acrylate compound in the polymerizable composition is preferably 0 to 40 parts by mass and more preferably 0 to 30 parts by mass with respect to the total amount of 100 parts by mass of the polymerizable compound.

(Polymerization Initiator)

The polymerizable composition includes two or more kinds of photopolymerization initiators in order to enable the curing due to light irradiation. The polymerization initiator is a compound that can be decomposed by exposure to generate an initiating species such as a radical, an acid, and a base, and is a compound that can initiate and promote the polymerization reaction of the polymerizable compound by this initiating species. Since the alicyclic epoxy compound is a compound that can perform cationic polymerization, the polymerizable composition preferably includes one or two or more kinds of photoacid generators as the polymerization initiator. Since the alicyclic epoxy compound is a compound that can perform anionic polymerization, the polymerizable composition preferably includes one or two or more kinds of photobase generators as the photopolymerization initiator.

Examples of the photoacid generator include paragraphs 0019 to 0024 of JP4675719B. The photoacid generator is included preferably by 0.1 to 10 parts by mass, more preferably by 0.2 to 8 parts by mass, and even more preferably by 0.2 to 5 parts by mass with respect to the total amount of the polymerizable compound included in the polymerizable composition. The use of the polymerization initiator in a suitable amount is preferable in view of reducing a light irradiation amount for curing and evenly curing the entire wavelength conversion layer.

Examples of the preferable photoacid generator include an iodonium salt compound, a sulfonium salt compound, a pyridinium salt compound, and a phosphonium salt compound. Examples of the anion portion (counter anion) included in the salt compound include CH₃SO₃⁻, C₆H₅SO₃⁻, CF₃SO₃⁻, PF₆⁻, HSbF₆⁻, and HB(C₆F₅)₄⁻. Among these, in view of curing speed, gas phase acidity of the anion portion is preferably an iodonium salt compound, a sulfonium salt compound, a pyridinium salt compound, a phosphonium salt compound in the range of 240 to 290 kcal/mol. The range of the gas phase acidity is more preferably 240 to 280 kcal/mol and even more preferably in the range of 240 to 270 kcal/mol.

Among these, in view of heat stability, an iodonium salt compound and a sulfonium salt compound are preferable. In view of suppressing the absorption of light derived from a light source of the wavelength conversion layer, an iodonium salt compound is particularly preferable. Specific Examples of the iodonium salt compound include Photoacid Generators (iodonium salt compounds) A and B described below. Specific Examples of the iodonium salt compound having an anion portion of which the gas phase acidity is in the range of 240 to 290 kcal/mol include Photoacid Generator (iodonium salt compound) C described below.

### Photoacid Generator (Iodonium Salt Compound) A

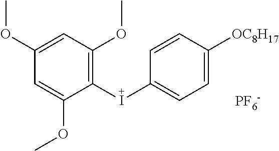

### Photoacid Generator (Iodonium Salt Compound) B

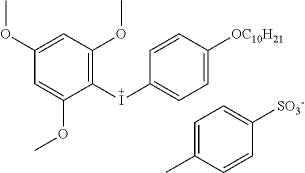

Photoacid Generator (iodonium salt compound) C

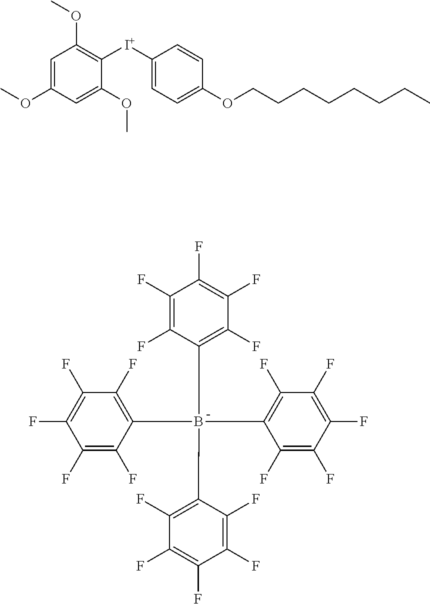

Absorption of light derived from light source of the wavelength conversion layer can be reduced by the means of the reduction of the content of the alicyclic epoxy compound and the combination of the (meth)acrylate compound as described above, regardless of the use of the iodonium salt compound, and thus the photoacid generator that can be added to the photocuring properties compound is not limited to the iodonium salt compound. Examples of the usable photoacid generator include one kind or a combination of two or more kinds of the following commercially available products. Examples thereof include CPI-110P, CPI-101A, CPI-110P, and CPI-200K manufactured by San Apro Ltd., WPI-113, WPI-116, WPI-124, WPI-169, and WPI-170 manufactured by Wako Pure Chemical Industries, Ltd., P1-2074 manufactured by Rhodia Japan, Ltd., IRGACURE (registered trademark) 250, IRGACURE (registered trademark) 270, and IRGACURE (registered trademark) 290 manufactured by BASF SE.

Meanwhile, as the photobase generator, for example, paragraphs 0039 to 0053 of JP2013-235216A can be referred to. The content of the photobase generator is preferably 0.1 to 10 parts by mass, more preferably 0.2 to 8 parts by mass, and even more preferably 0.2 to 5 parts by mass with respect to the total amount of the polymerizable compound included in the polymerizable composition.

In a case where the polymerizable composition includes a radical polymerizable compound, the polymerizable composition may contain one or two or more kinds of photo radical generators. As the photo radical generator, for example, paragraph 0037 of JP2013-043382A and paragraphs 0040 to 0042 of JP2011-159924A can be referred to. The content of the photo radical generator is preferably 0.1 to 10 parts by mass, more preferably 0.2 to 8 parts by mass, and even more preferably 0.2 to 5 parts by mass with respect to the total amount of the polymerizable compound included in the polymerizable composition.

(Other Additives)

The polymerizable composition according to the present invention may contain a viscosity adjuster, a solvent, and a silane coupling agent.

—Viscosity Adjuster—

The polymerizable composition may include a viscosity adjuster, if necessary. In a case where the viscosity adjuster is added, these can be adjusted to the desired viscosity. The viscosity adjuster is preferably a filler having a particle diameter of 5 nm to 300 nm. The viscosity adjuster may be a thixotropic agent. In the present invention and the present specification, thixotropic properties refer to properties of decreasing the viscosity with according to the increase of the shear rate in a liquid composition and the thixotropic agent refers to a material having a function of applying thixotropic properties to a composition by causing this to be included in the liquid composition. Specific Examples of the thixotropic agent include fumed silica, alumina, silicon nitride, titanium dioxide, calcium carbonate, zinc oxide, talc, mica, feldspar, kaolinite (kaolin clay), pyrophyllite (wax rock), sericite (silk mica), bentonite, smectite*vermiculites (montmorillonite, beidellite, nontronite, saponite, and the like), organic bentonite, and organic smectite.

—Solvent—

The polymerizable composition according to the present invention may include a solvent, if necessary. An organic solvent, water, or alcohol are preferably used in the solvent. Examples of the organic solvent include amide (for example, N,N-dimethylformamide), sulfoxide (for example, dimethylsulfoxide), a heterocyclic compound (for example, pyridine), hydrocarbon (for example, benzene, hexane, and toluene), alkyl halide (for example, chloroform and dichloromethane), ester (for example, methyl acetate, ethyl acetate, and butyl acetate), ketone (for example, acetone and methyl ethyl ketone), and ether (for example, tetrahydrofuran and 1,2-dimethoxyethane). The types and added amounts of the solvent used in this case are not particularly limited. The added amount is preferably 0 to 50 parts by mass with respect to 100 parts by mass of the polymerizable composition, in view of optimizing the viscosity of the polymerizable composition. Examples of aqueous or alcohol-based solvents include water, methanol, propanol, butanol, isopropyl alcohol, ethylene glycol, propylene glycol, and butanediol. A protonic solvent such as water and alcohol can accelerate the chain transfer agent reaction of epoxy polymerization, and the added amount of the solvent used in this case is preferably 0 to 10 parts by mass in 100 parts by mass of the polymerizable composition.

—Silane Coupling Agent—

The polymerizable composition may further include a silane coupling agent. The wavelength conversion layer formed of the polymerizable composition including a silane coupling agent can exhibit excellent light fastness since adhesiveness to the adjacent layer becomes strong due to the silane coupling agent. This is mainly because the silane coupling agent contained in the wavelength conversion layer forms a covalent bond with a surface of the adjacent layer or a constituent component of the layer due to hydrolysis reaction or condensation reaction. At this point, it is preferable to provide an inorganic layer described below as the adjacent layer. In a case where the silane coupling agent has a reactive functional group such as a radical polymerizable group, the forming a crosslinked structure with the monomer component forming the wavelength conversion layer can contribute to the adhesiveness improvement between the wavelength conversion layer and the adjacent layer. According to the present specification, the silane coupling agent included in the wavelength conversion layer has a meaning of also including a silane coupling agent in the form after the reaction as above.

As the silane coupling agent, well-known silane coupling agents can be used without limitation. In view of the adhesiveness, examples of the preferable silane coupling agent include a silane coupling agent represented by Formula (1) of JP2013-43382A. With respect to the details thereof, disclosures of paragraphs 0011 to 0016 of JP2013-43382A can be referred to. The used amount of the additive such as the silane coupling agent is not particularly limited, and can be suitably set.

The method of the polymerizable composition is not particularly limited, and may be performed according to a general preparation procedure of the polymerizable composition.

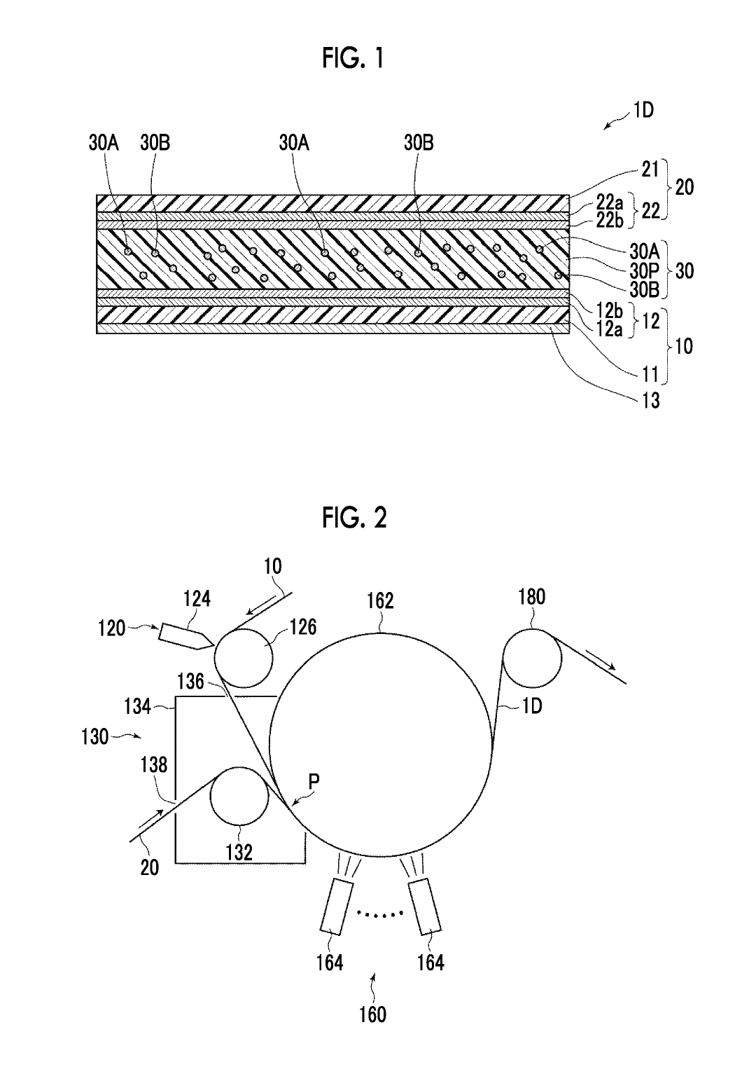

Subsequently, with reference to the drawings, a wavelength conversion member which is an embodiment according to the present invention and a backlight unit including the wavelength conversion member. FIG. 1 is a schematic structural cross-sectional view of a wavelength conversion member according to the present embodiment.

[Wavelength Conversion Member]

As illustrated in FIG. 1, a wavelength conversion member 1D according to the present embodiment includes a wavelength conversion layer 30 obtained by curing the polymerizable composition and barrier films 10 and 20 disposed on both main surfaces of the wavelength conversion layer 30. Here, the “main surface” refers to a surface (front surface or back surface) of the wavelength conversion layer disposed on a viewing side or a backlight side in a case where the wavelength conversion member is used in the display device described below. The same is applied to the main surfaces of the other layers or members. The barrier films 10 and 20 respectively include barrier layers 12 and 22 and supports 11 and 21, respectively from the wavelength conversion layer 30. Hereinafter, details of the wavelength conversion layer 30, the barrier films 10 and 20, the supports 11 and 21, and the barrier layers 12 and 22 are described.

(Wavelength Conversion Layer)

As illustrated in FIG. 1, with respect to the wavelength conversion layer 30, quantum dots 30A that emit the fluorescence (red light) L_{R} excited by the blue light L_{B} and quantum dots 30B that emit fluorescence (green light) L_{G} excited by the blue light L_{B} are dispersed in an organic matrix 30P, and the quantum dots 30A and 30B in FIG. 1 are described largely for easy visual recognition, but a diameter of the quantum dots, for example, is in the range of 2 to 7 nm with respect to 50 to 100 μm of the thickness of the wavelength conversion layer 30, in practice.

The ligands according to the present invention are coordinated to the surfaces of the quantum dots 30A and 30B. The wavelength conversion layer 30 is obtained by curing the polymerizable composition including the quantum dots 30A and 30B to which the ligands according to the present invention are coordinated, the polymerizable compound, and the polymerization initiator due to the light irradiation.

The organic matrix 30P is obtained by curing the polymerizable compound due to light irradiation or heat.

The thickness of the wavelength conversion layer 30 is preferably in the range of 1 to 500 μm, more preferably in the range of 10 to 250 μm, and even more preferably in the range of 30 to 150 μm. In a case where the thickness is 1 μm or greater, the high wavelength conversion effect can be obtained, and thus is preferable. If the thickness is 500 μm or less, in a case where the wavelength conversion layer 30 is combined with the backlight unit, it is possible to cause the backlight unit to be thin, and thus is preferable.

According to the embodiment, an embodiment using blue light as a light source is used, in the wavelength conversion layer 30, the quantum dots 30A that emit the fluorescence (red light) L_{R} excited by the ultraviolet light L_{UV} in the organic matrix 30P the quantum dots 30B that emit the fluorescence (green light) L_{G} excited by the ultraviolet light L_{UV}, and the quantum dots 30C (as illustrated) that emit the fluorescence (blue light) L_{B} excited the ultraviolet light L_{UV} may be dispersed. The shape of the wavelength conversion layer is not particularly limited, and an arbitrary shape thereof can be used.

(Barrier Film)

The barrier films 10 and 20 are films having a gas barrier function to block oxygen. According to the present embodiment, the barrier layers 12 and 22 are respectively included in the supports 11 and 21. According to the existence of the supports 11 and 21, the strength of the wavelength conversion member 1D is improved, and the respective layers can be easily formed.

According to the present embodiment, the barrier films 10 and 20 in which the barrier layers 12 and 22 are supported by the supports 11 and 21 are provided, but the barrier layers 12 and 22 may not be supported by the supports 11 and 21. According to the present embodiment, the wavelength conversion member in which the barrier layers 12 and 22 are included to be adjacent to the both main surfaces of the wavelength conversion layer 30 is provided. However, in a case where the supports 11 and 21 have sufficient barrier properties, the barrier layer may only include the supports 11 and 21.

As provided in the present embodiment, as the barrier films 10 and 20, an aspect in which two barrier films are included in the wavelength conversion member is preferable, but an aspect in which only one barrier film is included is possible.

In the barrier films 10 and 20, the total light transmittance in the visible light region is preferably 80% or greater and more preferably 90% or greater. The visible light region refers to a wavelength area of 380 to 780 nm, and the total light transmittance indicates an average value of the light transmittance in the visible light region.

The oxygen transmittance of the barrier films 10 and 20 is preferably 1.00 cm³/(m²·day·atm) or less. Here, the oxygen transmittance is a value measured by using an oxygen gas transmittance determination device (product name: “OX-TRAN 2/20”, manufactured by MOCON Inc.) under the conditions of the measuring temperature of 23° C. and relative humidity of 90%. The oxygen transmittance of the barrier films 10 and 20 is more preferably 0.10 cm³/(m²·day·atm) or less and even more preferably 0.01 cm³/(m²·day·atm) or less. The oxygen transmittance of 1.00 cm³/(m²·day·atm) is 1.14×10⁻¹ fm/Pa·s in terms of the SI unit system.

(Support)

In the wavelength conversion member 1D, at least one of the main surfaces of the wavelength conversion layer 30 is supported by a support 11 or 21. According to the present embodiment, in the wavelength conversion layer 30, it is preferable that the front and back main surfaces of the wavelength conversion layer 30 are supported by the supports 11 and 21.

In view of impact resistance of the wavelength conversion member or the like, the average film thickness of the supports 11 and 21 is preferably 10 μm to 500 μm, more preferably 20 μm to 400 μm, and even more preferably 30 μm to 300 μm. As a case where the concentrations of the quantum dots 30A and 30B included in the wavelength conversion layer 30 are decreased or a case where the thickness of the wavelength conversion layer 30 is decreased, in an aspect in which the retroreflection of light is increased, it is preferable that the absorbance of light at a wavelength of 450 nm is decreased. Therefore, in view of suppressing the decrease of the brightness, the average film thicknesses of the supports 11 and 21 are preferably 40 μm or less and even more preferably 25 μm or less.

In order to decrease the concentration of the quantum dots 30A and 30B included in the wavelength conversion layer 30 or in order to decrease the thickness of the wavelength conversion layer 30, it is required to increase the number of times for which the excitation light passes through the wavelength conversion layer, by providing means for increasing retroreflection of light, for example, providing a plurality of prism sheets in the retroreflecting member of the backlight unit described below for maintaining the LCD display color. Accordingly, the support is preferably a transparent support which is transparent to visible light.

Here, the expression “transparent to visible light” means that the light transmittance in the visible light region is 80% or greater and preferably 85% or greater. The light transmittance used as the transparency scale can be calculated by measuring the total light transmittance and the scattered light quantities in the method disclosed in JIS-K7105, that is, by using an integrating spherical light transmittance measuring device and subtracting the diffuse transmittance from the total light transmittance. With respect to the support, paragraphs 0046 to 0052 of JP2007-290369A and paragraphs 0040 to 0055 of JP2005-096108A can be referred to.

In the supports 11 and 21, it is preferable that the in-plane retardation Re (589) at the wavelength of 589 nm is 1,000 nm or less. The in-plane retardation is more preferably 500 nm or less and even more preferably 200 nm or less.

After the wavelength conversion member 1D is produced, in a case where whether foreign matters or defects exist or not is examined, two polarizing plates are disposed in an extinction position, the wavelength conversion member is interposed therebetween and observed so as to easily observe foreign matters or defects. In a case where the Re (589) of the support is in the range described above, in a case of examination using the polarizing plate, foreign matters or defects are easily found, and thus the range is preferable.

Here. Re (589) is measured by causing light at a wavelength of 589 nm to be incident to KOBRA-21ADH or KOBRA WR (manufactured by Oji Scientific Instruments). With respect to the selection of the measurement wavelength λ nm, Re (589) can be measured by manually changing the wavelength selective filter or by converting the measured value with a program or the like.

As the supports 11 and 21, a support having barrier properties against oxygen and moisture is preferable. Preferable examples of the support include a polyethylene terephthalate film, a film consisting of a polymer having a cyclic olefin structure, and a polystyrene film.

(Barrier Layer)

The barrier layers 12 and 22 respectively include organic layers 12a and 22a and inorganic layers 12b and 22b in an order from the supports 11 and 21. The organic layers 12a and 22a are provided between the inorganic layers 12b and 22b and the wavelength conversion layer 30.

The barrier layers 12 and 22 are formed by forming layers on the surfaces of the supports 11 and 21. Accordingly, the barrier films 10 and 20 includes the supports 11 and 21 and the barrier layers 12 and 22 provided thereon. In a case where the barrier layers 12 and 22 are provided, the support preferably has high heat resistance. In the wavelength conversion member 1D, the layers in the barrier films 10 and 20 that are adjacent to the wavelength conversion layer 30 may be inorganic layers or may be an organic layer, and are not particularly limited.

In a case where the barrier layers 12 and 22 include a plurality of layers, barrier properties can be further increased, and thus it is preferable that the barrier layers 12 and 22 include a plurality of layers, in view of improvement of light fastness. However, as the number of layers increases, the light transmittance of the wavelength conversion member tends to decrease, and thus it is preferable that the design is performed considering satisfactory light transmittance and satisfactory barrier properties.

—Inorganic Layer—

The inorganic layer is a layer using an inorganic material as a main component, is preferably a layer in which inorganic material occupies by 50 mass % or greater, more by 80 mass % or greater, and particularly by 90 mass % or greater is preferable, and is most preferably a layer formed only of an inorganic material. The inorganic layers 12b and 22b suitable for the barrier layers 12 and 22 are not particularly limited, and various inorganic compounds such as metal, inorganic oxide, nitride, and oxynitride can be used. As the elements included in the inorganic material, silicon, aluminum, magnesium, titanium, tin, indium, and cerium are preferable, and one or two or more kinds of these may be included. Specific Examples of the inorganic compound include silicon oxide, silicon oxynitride, aluminum oxide, magnesium oxide, titanium oxide, tin oxide, an indium oxide alloy, silicon nitride, aluminum nitride, and titanium nitride. As the inorganic layer, a metal film, for example, an aluminum film, a silver film, a tin film, a chromium film, a nickel film, or a titanium film may be provided.

Among the above materials, an inorganic layer including silicon oxide, silicon nitride, silicon oxynitride, silicon carbide, or aluminum oxide is particularly preferable. Since the inorganic layer consisting of these materials has satisfactory adhesiveness to an organic layer, even in a case where there are pin holes in the inorganic layer, the pin holes are effectively filled with the organic layer, and barrier properties can be further increased.

In view of suppressing absorption of the light in the barrier layer, silicon nitride is most preferable.

The method of forming an inorganic layer is not particularly limited, and various film forming methods in which the film forming material can be evaporated or scattered and can be deposited on the vapor deposited surface.

Examples of the method of forming an inorganic layer include a vacuum deposition method in which an inorganic material such as inorganic oxide, inorganic nitride, inorganic oxynitride, or metal is heated and vapor deposited; an oxidation reaction evaporation method in which an inorganic material is used as a raw material and is oxidized and vaporized by introducing oxygen gas; a sputtering method in which an inorganic material is used as a target raw material and is vapor deposited by introducing argon gas and oxygen gas and performing sputtering; a physical vapor deposition method (PVD method) such as an ion plating method in which an inorganic material is heated by a plasma beam generated by a plasma gun and vapor deposited, and, in a case where a vapor deposited film of silicon oxide is formed, a plasma chemical vapor deposition method (CVD method) in which an organic silicon compound is used as a raw material.

The thickness of the inorganic layer may be 1 nm to 500 nm, preferably 5 nm to 300 nm, and particularly more preferably 10 nm to 150 nm. In a case where the thickness of the adjacent inorganic layer is in the range described above, satisfactory barrier properties can be realized, absorption of light in the inorganic layer can be suppressed, and a wavelength conversion member having higher light transmittance can be provided.

—Organic Layer—

The organic layer is a layer using an organic material as a main component, and is preferably a layer in which the layer in which organic material occupies by 50 mass % or greater, more by 80 mass % or greater, and particularly by 90 mass % or greater. As the organic layer, paragraphs 0020 to 0042 of JP2007-290369A and paragraphs 0074 to 0105 of JP2005-096108A can be referred to. The organic layer preferably includes a cardo polymer. This is because, adhesiveness between the organic layer and the adjacent layer is satisfactory, particularly, adhesiveness to the inorganic layer is also satisfactory, and excellent barrier properties can be accordingly realized. As the details of the cardo polymer, paragraphs 0085 to 0095 disclosed in JP2005-096108A described above can be referred to. The film thickness of the organic layer is preferably in the range of 0.05 μm to 10 μm, and among these, it is preferable that the film thickness is in the range of 0.5 to 10 μm. In a case where the organic layer is formed in a set coating method, the film thickness of the organic layer is in the range of 0.5 to 10 μm, and among these, it is preferable that the film thickness is in the range of 1 μm to 5 μm. In a case where the organic layer is formed in a dry coating method, the film thickness is in the range of 0.05 μm to 5 μm, and among these, it is preferable that the film thickness is in the range of 0.05 μm to 1 μm. This is because, in a case where the film thickness of the organic layer formed in the wet coating method or the dry coating method is in the range described above, adhesiveness to the inorganic layer can be caused to be more satisfactory.

With respect to other details of the inorganic layer and the organic layer, disclosure in JP2007-290369A, JP2005-096108A, and further US2012/0113672A1 described above can be referred to.

In the wavelength conversion member 1D, the wavelength conversion layer, the inorganic layer, the organic layer, and the support are laminated in this order, or the support is disposed between the inorganic layer and the organic layer, between two organic layers, or two inorganic layers, to be laminated.

(Unevenness Imparting Layer (Also Referred to as Mat Layer))

A barrier film 10 preferably includes an unevenness imparting layer 13 of applying an unevenness structure to a surface on the wavelength conversion layer 30 side and the opposite surface. In a case where the barrier film 10 has the unevenness imparting layer 13, blocking properties and slipping properties of the barrier film can be improved, and thus the unevenness imparting layer 13 is preferable. The unevenness imparting layer is preferably a layer containing particles. The particles include inorganic particles such as silica, alumina, and metal oxide or organic particles such as crosslinked polymer particles. It is preferable that the unevenness imparting layer and the wavelength conversion layer of the barrier film are provided on the opposite surface, but may be provided on both surfaces.

The wavelength conversion member 1D can have a light scattering function to efficiently extract the fluorescence of quantum dots to the outside. The light scattering function may be provided inside the wavelength conversion layer 30 or a layer having a light scattering function may be separately provided as the light scattering layer. The light scattering layer may be provided on the surface on the wavelength conversion layer 30 side of a barrier layer 22 and may be provided on an opposite surface of the wavelength conversion layer of the support. In a case where the unevenness imparting layer is provided, it is preferable that the unevenness imparting layer is a layer that can also used as the light scattering layer.

<Method of Manufacturing Wavelength Conversion Member>

Subsequently, an example of a method of manufacturing the wavelength conversion member 1D in an aspect of having the barrier films 10 and 20 including the barrier layers 12 and 22 on the supports 11 and 21 on the both surfaces of the wavelength conversion layer 30 is described.

According to the present embodiment, the wavelength conversion layer 30 can be formed by coating the surfaces of the barrier films 10 and 20 with a prepared polymerizable composition and curing the prepared polymerizable composition with light irradiation or heating. Examples of the coating method include the well-known coating methods such as a curtain coating method, a dip coating method, a spin coating method, a printing coating method, a spray coating method, a slot coating method, a roll coating method, a slide coating method, a blade coating method, a gravure coating method, and a wire bar method.

The curing condition can be appropriately set according to the kinds of the used anion polymerizable compound or the composition of the polymerizable composition. In a case where the polymerizable composition is a composition including a solvent, a drying treatment can be performed before curing in order to remove the solvent.

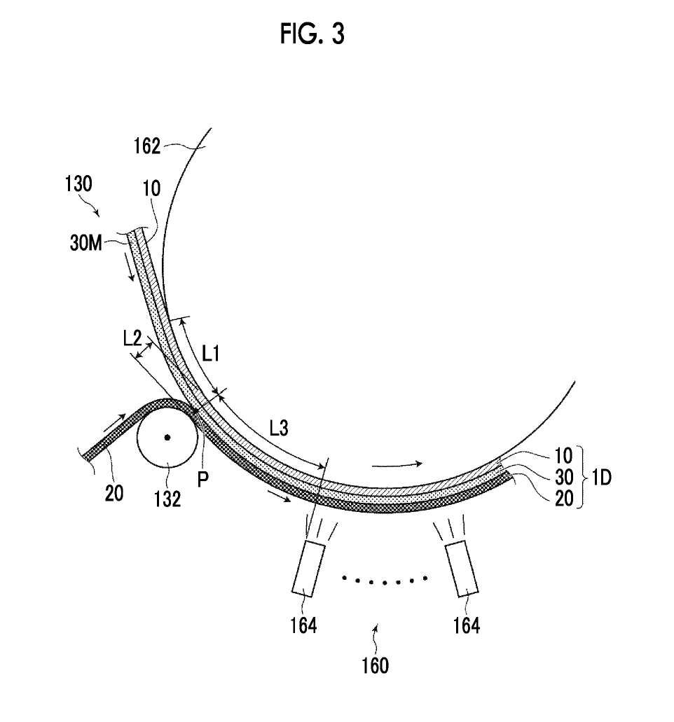

The polymerizable composition may be cured in a state in which the polymerizable composition is interposed between two supports. An aspect of a step of manufacturing a wavelength conversion member including a curing treatment is described below with reference to FIGS. 2 and 3. Here, the present invention is not limited to the aspect.

FIG. 2 is a schematic structural view of an example of a manufacturing device of the wavelength conversion member 1D, and FIG. 3 is a partial enlarged view of the manufacturing device illustrated in FIG. 2.

The manufacturing device of the present embodiment includes a sending machine (not illustrated), a coating unit 120 that coats the first barrier film 10 with the polymerizable composition to form a coating film 30M, a laminating unit 130 obtained by bonding a second barrier film 20 to the coating film 30M and holding the coating film 30M between the first barrier film 10 and the second barrier film 20, a curing unit 160 that cures the coating film 30M, and a winding machine (not illustrated).

A step of manufacturing a wavelength conversion member using the manufacturing device illustrated in FIGS. 2 and 3 at least includes a step of forming a coating film and coating a surface of the first barrier film 10 (hereinafter, referred to as a “first film”) continuously transported, with the polymerizable composition, a step of laminating (overlapping) the second barrier film 20 (hereinafter, referred to as a “second film”) continuously transported, on the coating film and holding the coating film between the first film and the second film, and a step of forming a wavelength conversion layer (cured layer) by winding any one of the first film and the second film in a state in which the coating film is held between the first film and the second film to the backup roller and polymerizing and curing the coating film by light irradiating while continuously transporting the coating film. According to the present embodiment, barrier films having barrier properties against oxygen or water are used in both of the first film and the second film. According to this aspect, the wavelength conversion member 1D in which the both surfaces of the wavelength conversion layer are protected by the barrier films can be obtained. The wavelength conversion member 1D may be a wavelength conversion member in which one surface is protected by a barrier film, and in this case, it is preferable that the barrier film side is used as a side close to the external air.

Specifically, first, the first film 10 is continuously transported from the sending machine (not illustrated) to the coating unit 120. For example, the first film 10 is sent in the transportation speed of 1 to 50 m/minute from the sending machine. Here, the present invention is not limited to this transportation speed. In a case of sending, for example, the tension of 20 to 150 N/m and preferably the tension of 30 to 100 N/m is applied to the first film 10.

In the coating unit 120, the surface of the first film 10 continuously transported is coated with the polymerizable composition (hereinafter, referred to as a “coating solution”) and the coating film 30M (see FIG. 3) is formed. In the coating unit 120, for example, a die coater 124 and a backup roller 126 disposed to face the die coater 124 are provided. The surface opposite to the surface on which the coating film 30M of the first film 10 is formed is wound around the backup roller 126, and the surface of the first film 10 continuously transported is coated with the coating solution from the discharging port of the die coater 124, to form the coating film 30M. Here, the coating film 30M is a polymerizable composition before curing with which the first film 10 is coated.

According to the present embodiment, the die coater 124 to which the extrusion coating method is applied is provided as the coating device in the coating unit 120, but the present invention is not limited thereto. For example, the coating device to which various methods such as a curtain coating method, a rod coating method, and a roll coating method are applied, can be used.

The first film 10 that passes through the coating unit 120 and on which the coating film 30M is formed is continuously transported to the laminating unit 130. In the laminating unit 130, the second film 20 continuously transported is laminated on the coating film 30M, the coating film 30M is held between the first film 10 and the second film 20.

The laminate roller 132 and a heating chamber 134 that surrounds the laminate roller 132 are provided on the laminating unit 130. An opening portion 136 through which the first film 10 passes and an opening portion 138 through which the second film 20 passes are provided in the heating chamber 134.

A backup roller 162 is disposed at a position that faces a laminate roller 132. With respect to the first film 10 on which the coating film 30M is formed, a surface opposite to the surface on which the coating film 30M is formed is wound around the backup roller 162 and continuously transported to a laminate position P. The laminate position P means a position at which the contact between the second film 20 and the coating film 30M starts. The first film 10 is preferably wound around the backup roller 162 before reaching the laminate position P. Even in a case where wrinkles are generated in the first film 10, wrinkles are straightened and removed until reaching the laminate position P due to the backup roller 162. Accordingly, it is preferable that a distance L1 from a position (contact position) at which the first film 10 is wound around the backup roller 162 to the laminate position P is long, for example, the distance L1 is preferably 30 mm or greater and the upper limit value thereof is generally determined by a diameter of the backup roller 162 and a path line.

According to the present embodiment, lamination of the second film 20 is performed by the backup roller 162 used in the curing unit 160 and the laminate roller 132. That is, the backup roller 162 used in the curing unit 160 is also used as a roller used in the laminating unit 130. However, the present invention is not limited to the embodiment, and independently from the backup roller 162, a roller for lamination is provided in the laminating unit 130 such that double use of the backup roller 162 is not performed.

The number of rollers can be reduced by using the backup roller 162 used in the curing unit 160 in the laminating unit 130. The backup roller 162 can be used as a heating roller to the first film 10.

The second film 20 sent from the sending machine (not illustrated) is wound around the laminate roller 132 and is continuously transported to a portion between the laminate roller 132 and the backup roller 162. The second film 20 is laminated on the coating film 30M formed on the first film 10 at the laminate position P. Accordingly, the coating film 30M is held between the first film 10 and the second film 20. The laminate is obtained by overlapping the second film 20 on the coating film 30M and perform lamination.

A distance L2 between the laminate roller 132 and the backup roller 162 is preferably equal to or greater than a total thickness value of the first film 10, the wavelength conversion layer (cured layer) 30 obtained by polymerizing and curing the coating film 30M, and the second film 20. L2 is preferably equal to or less than a length obtained by adding 5 mm to the total thickness of the first film 10, the coating film 30M, and the second film 20. In a case where the distance L2 is equal to or less than a length obtained by adding 5 mm to the total thickness, it is possible to prevent the intrusion of bubbles between the second film 20 and the coating film 30M. Here, the distance L2 between the laminate roller 132 and the backup roller 162 is the shortest distance between an outer peripheral surface of the laminate roller 132 and an outer peripheral surface of the backup roller 162.

The rotation accuracy of the laminate roller 132 and the backup roller 162 is 0.05 mm or less and preferably 0.01 mm or less by radial runout. As the radial runout is smaller, the thickness distribution of the coating film 30M can be reduced.

In order to suppress thermal deformation after holding the coating film 30M between the first film 10 and the second film 20, a difference between the temperature of the backup roller 162 of the curing unit 160 and the temperature of the first film 10 and a difference between the temperature of the backup roller 162 and the temperature of the second film 20 is preferably 30° C. or less, more preferably 15° C. or less, and most preferably the same.

In order to reduce the difference with the temperature of the backup roller 162, in a case where the heating chamber 134 is provided, it is preferable to heat the first film 10 and the second film 20 in the heating chamber 134. For example, the first film 10 and the second film 20 can be heated by supplying hot air by a hot air generator (not illustrated) to the heating chamber 134.

Since the first film 10 can be wound around the backup roller 162 of which the temperature is adjusted, the first film 10 may be heated by the backup roller 162.

Meanwhile, with respect to the second film 20, in a case where the laminate roller 132 is caused to be a heating roller, the second film 20 can be heated by the laminate roller 132. Here, the heating chamber 134 and the heating roller are not indispensable, and can be provided, if necessary.

Subsequently, the coating film 30M is held between the first film 10 and the second film 20 and continuously transported to the curing unit 160. In the aspect illustrated in the drawings, the curing in the curing unit 160 is performed by light irradiation, but in a case where the polymerizable compound included in the polymerizable composition is polymerized by heating, curing can be performed by heating of blowing of hot air or the like.

At the position facing the backup roller 162, light irradiation devices 164 are provided. The first film 10 and the second film 20 that hold the coating film 30M therebetween are continuously transported to a portion between the backup roller 162 and the light irradiation devices 164. The light irradiated by the light irradiation device may be determined according to the kinds of photopolymerizable compounds included in the polymerizable composition, and examples thereof include ultraviolet rays. Here, the ultraviolet rays refer to light having a wavelength of 280 to 400 nm. As the light source that generates ultraviolet rays, a low pressure mercury lamp, a medium pressure mercury lamp, a high pressure mercury lamp, an extra high pressure mercury lamp, a carbon arc lamp, a metal halide lamp, and a xenon lamp can be used. The amount of the light irradiation may be set in the range obtained by in a range in which the polymerization curing of the coating film can proceed, and for example, the coating film 30M can be irradiated with the ultraviolet rays in the irradiation amount of 100 to 10,000 mJ/cm², as an example.

In the curing unit 160, in a state in which the coating film 30M is held between the first film 10 and the second film 20, the first film 10 is wound around the backup roller 162 and continuously transported, light irradiation is performed from the light irradiation devices 164, and the coating film 30M is cured, so as to form the wavelength conversion layer 30.

According to this embodiment, the first film 10 side is wound around the backup roller 162 and continuously transported, but the second film 20 may be wound around the backup roller 162 and continuously transported.

The expression of “wound around the backup roller 162” means a state in which any one of the first film 10 and the second film 20 is in contact with the surface of the backup roller 162 in a certain wrap angle. Accordingly, in a case of being continuously transported, the first film 10 and the second film 20 are synchronized with the rotation of the backup roller 162 and moved. The winding of the backup roller 162 may be performed while irradiation with at least ultraviolet rays is performed.

The backup roller 162 includes a main body having a cylindrical shape and rotating shafts disposed at both end portions of the main body. The main body of the backup roller 162 has a diameter of φ 200 to 1,000 mm. The diameter φ of the backup roller 162 is not limited. Considering curl deformation of the laminated film, equipment cost, and rotation accuracy, the diameter is preferably φ 300 to 500 mm. The temperature of the backup roller 162 can be adjusted by installing a temperature controller to the main body of the backup roller 162.

The temperature of the backup roller 162 can be determined by considering the heat generation during light irradiation, the curing efficiency of the coating film 30M, and the occurrence of wrinkle deformation of the first film 10 and the second film 20 on the backup roller 162. The backup roller 162 is preferably set in the temperature range of 10° C. to 95° C. and more preferably set in the temperature range of 15° C. to 85° C. Here, the temperature relating to the roller refers to the surface temperature of the roller.

A distance L3 between the laminate position P and the light irradiation devices 164 can be set, for example, as 30 mm or greater.

The coating film 30M is cured by light irradiation to be the wavelength conversion layer 30, and the wavelength conversion member 1D including the first film 10, the wavelength conversion layer 30, and the second film 20 is manufactured. The wavelength conversion member 1D is peeled off from the backup roller 162 by a peeling roller 180. The wavelength conversion member 1D is continuously transported to the winding machine (not illustrated) and subsequently the wavelength conversion member 1D is wound in a roll shape by the winding machine.

[Backlight Unit]

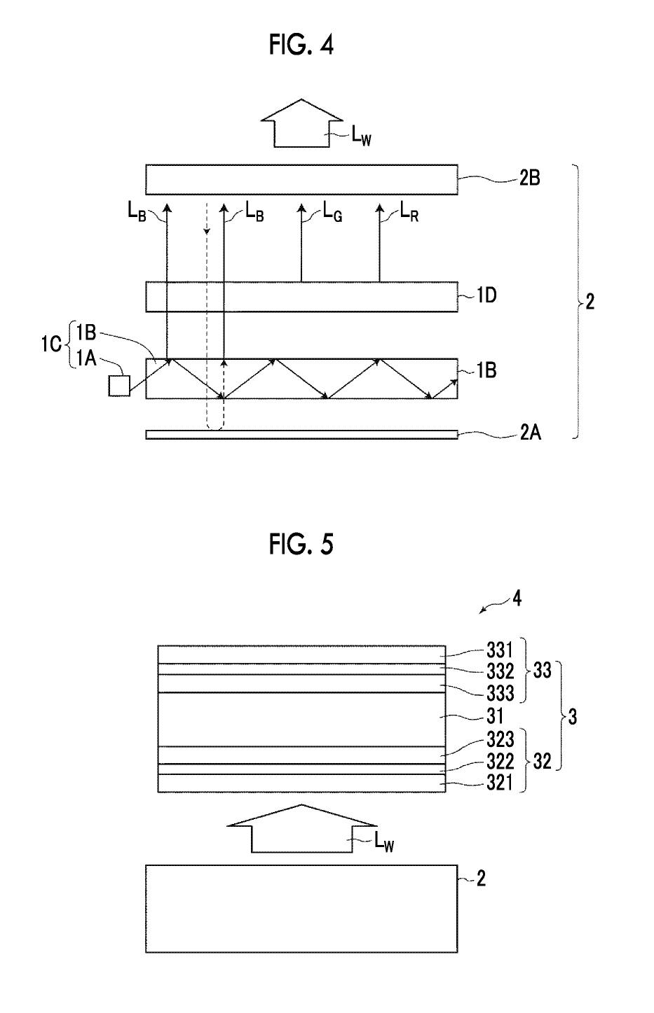

Subsequently, the backlight unit including the wavelength conversion member according to the present invention is described. FIG. 4 is a schematic structural cross-sectional view illustrating a backlight unit.

As illustrated in FIG. 4, a backlight unit 2 according to the present invention includes a surface light source 1C consisting of a light source 1A that emits primary light (the blue light L_{B}) and a light guide plate 1B that guides the primary light emitted from the light source 1A, the wavelength conversion member 1D included on the surface light source 1C, a retroreflecting member 2B disposed to face the surface light source 1C with the wavelength conversion member 1D interposed therebetween, and a reflecting plate 2A disposed to face the wavelength conversion member 1D with the surface light source 1C interposed therebetween. The wavelength conversion member 1D emits fluorescence by using at least a portion of the primary light L_{B} emitted from the surface light source 1C as excitation light and emits secondary light (the green light L_{G} and the red light L_{R}) consisting of this fluorescence and the primary light L_{B} that pass through the wavelength conversion member 1D. White light L_{w} is emitted from the surface of the retroreflecting member 2B due to L_{G}, L_{R}, and L_{B}.

The shape of the wavelength conversion member 1D is not particularly limited and may be an arbitrary shape such as a sheet shape or a bar shape.

In FIG. 4, L_{B}, L_{C} and L_{R} emitted from the wavelength conversion member 1D are incident to the retroreflecting member 2B, and each of the incident light repeats the reflection between the retroreflecting member 2B and the reflecting plate 2A and passes through the wavelength conversion member 1D many times. As a result, in the wavelength conversion member 1D, the excitation light (the blue light L_{B}) in a sufficient amount is absorbed by the quantum dots 30A that emit the red light L_{R} and the quantum dots 30B that emit the green light L_{G}, the fluorescence (the green light L_{G} and the red light L_{R}) in a necessary amount is emitted, and the white light L_{W} is embodied from the retroreflecting member 2B and emitted.

In a case where the ultraviolet light is used as the excitation light, the white light can be embodied by red light emitted by the quantum dots 30A, green light emitted by the quantum dots 30B, and blue light emitted by the quantum dots 30C, by causing the ultraviolet light to be incident to the wavelength conversion layer 30 including the quantum dots 30A. 30B, and 30C (not illustrated) in FIG. 1 as excitation light.

In view of achieving high brightness and high color reproducibility, it is preferable to use a backlight unit that has been converted into a multi-wavelength light source. For example, it is preferable to emit blue light having a center emission wavelength in a wavelength range of 430 to 480 nm and having a peak of emission intensity in which the half-width is 100 nm or less, green light having a center emission wavelength in a wavelength range of 520 to 560 nm and having a peak of emission intensity in which the half-width is 100 nm or less, and red light having a center emission wavelength in a wavelength range of 600 to 680 nm and having a peak of emission intensity in which the half-width is 100 nm or less.

In view of further improvement of brightness and color reproducibility, the wavelength range of the blue light emitted by the backlight unit is more preferably 440 to 460 nm.

In the same point of view, the wavelength range of the green light emitted by the backlight unit is more preferably 520 to 545 nm.

In the same point of view, the wavelength range of the red light emitted by the backlight unit is more preferably 610 to 640 nm.

In the same point of view, the half-width of each of the emission intensity of the blue light, the green light and the red light that are emitted by backlight unit is preferably 80 nm or less, more preferably 50 nm or less, even more preferably 40 nm or less, and still even more preferably 30 nm or less. Among these, the half-width of the emission intensity of blue light is particularly preferably 25 nm or less.

The backlight unit 2 at least includes the surface light source 1C together with the wavelength conversion member 1D. Examples of the light source 1A include a light source that emits blue light having a center emission wavelength in a wavelength range of 430 nm to 480 nm or a light source that emits ultraviolet light. As the light source 1A, a light emitting diode, a light source, and the like can be used.

As illustrated in FIG. 4, the surface light source 1C may be a light source consisting of the light source 1A and the light guide plate 1B that guides and emits the primary light emitted from the light source 1A and may be a light source in which the light source 1A is disposed in a planar shape parallel to the wavelength conversion member 1D and a diffusion plate instead of the light guide plate 1B. The former light source is generally called an edge light mode and the latter light source is called a direct backlight mode.

In FIG. 4, as the configuration of the backlight unit, an edge light mode using the light guide plate, the reflecting plate, or the like as configuration members is described, but the backlight unit may be the direct back light mode. As the light guide plate, well-known light guide plates may be used without limitation.

According to the present embodiment, a case where the surface light source is used as the light source is described, but a light source other than the surface light source can be used as the light source.

In a case where the light source that emits blue light is used, in the wavelength conversion layer, the quantum dots 30A that are excited by at least excitation light and emit red light and the quantum dots 30B that emit green light are preferably included. Accordingly, the white light is embodied by blue light that is emitted from the light source and that passes through the wavelength conversion member and red light and green light that are emitted from the wavelength conversion member.

According to another aspect, as the light source, a light source (ultraviolet light source) that emits ultraviolet light having a center emission wavelength in the wavelength range of 300 nm to 430 nm, for example, an ultraviolet light emitting diode can be used. According to another aspect, a laser light source can be used instead of the light emitting diode.

The reflecting plate 2A is not particularly limited, and well-known plates can be used and are disclosed in JP3416302B, JP3363565B, JP4091978B, and JP3448626B, and the contents thereof are incorporated to the present invention.

The retroreflecting member 2B may include well-known diffusion plates, diffusion sheets, prism sheets (for example, BEF series manufactured by Sumimoto 3M Limited), or reflective type polarizing film (for example, DBEF series manufactured by Sumimoto 3M Limited). The configuration of the retroreflecting member 2B is disclosed in JP3416302B, JP3363565B, JP4091978B, and JP3448626B, and the contents thereof are included in the present invention.

[Liquid Crystal Display Device]

The backlight unit 2 described above can be applied to the liquid crystal display device. FIG. 5 is a schematic structural cross-sectional view of the liquid crystal display device according to the present invention.

As illustrated in FIG. 5, a liquid crystal display device 4 includes the backlight unit 2 according to the above embodiment and a liquid crystal cell unit 3 disposed to face the retroreflecting member 2B side in the backlight unit 2. The liquid crystal cell unit 3 has a configuration of holding a liquid crystal cell 31 between polarizing plates 32 and 33, and the polarizing plates 32 and 33 have a configuration of protecting both main surfaces of polarizers 322 and 332 to be protected by polarizing plate protective films 321, 323, 331, and 333.

The liquid crystal cell 31 and the polarizing plates 32 and 33 included in the liquid crystal display device 4 and the components are not particularly limited. Those produced in the well-known methods or commercially available products may be used without limitation. It is possible to provide a well-known interlayer such as an adhesive layer between respective layers.

The driving mode of the liquid crystal cell 31 is not particularly limited, and various modes such as twisted nematic (TN), super twisted nematic (STN), vertical alignment (VA), in-plane switching (IPS), and optically compensated bend (OCB) cell may be used. The liquid crystal cell is preferably a VA mode, an OCB mode, an IPS mode, or a TN mode, but the present invention is not limited thereto. The configuration of the liquid crystal display device in the VA mode includes a configuration illustrated in FIG. 2 of JP2008-262161A. Here, the specific configuration of the liquid crystal display device is not particularly limited, and well-known configurations can be employed.

The liquid crystal display device 4 may further include an optical compensating member that performs optical compensation, an accompanying functional layer such as an adhesive layer, and the like. A surface layer such as a forward scattering layer, a primer layer, an antistatic layer, or an undercoat layer may be disposed together with or instead of a color filter substrate, a thin layer transistor substrate, a lens film, a diffusion sheet, a hard coat layer, an antireflection layer, a low reflection layer, an anti-glare layer, and the like.

The polarizing plate 32 on the backlight side may have a retardation film as the polarizing plate protective film 323 on the liquid crystal cell 31 side. As the retardation film, a well-known cellulose acylate film and the like can be used.

The backlight unit 2 and the liquid crystal display device 4 have satisfactory initial brightness according to the present invention and include wavelength conversion members in which the deterioration of the brightness is reduced, to be a backlight unit and a liquid crystal display device with high brightness.

### EXAMPLES

Hereinafter, the present invention is specifically described with reference to examples. Materials, used amounts, ratios, treatment details, and treatment procedures provided in the following examples can be suitably changed without departing from the gist of the present invention. Accordingly, the scope of the present invention may not be construed to be limited to the specific examples provided below.

(Production of Barrier Film 10)

An organic layer and an inorganic layer were sequentially formed on one side of a support by the following order procedures by using a polyethylene terephthalate (PET) film (manufactured by Toyobo Co., Ltd., product name “COSMOSHINE (registered trademark) A4300”, thickness: 50 μm) as the support.

(Forming of Organic Layer)

Trimethylolpropane triacrylate (product name “TMPTA”, manufactured by Daicel-Allnex Ltd.) and a photopolymerization initiator (product name “ESACURE (registered trademark) KT046”, manufactured by Lamberti S.p.A.) were prepared and weighed to have a mass ratio of 95:5, and these were dissolved in methyl ethyl ketone to obtain a coating solution having a solid content concentration of 15%. A PET film was coated with this coating solution by roll to roll using a die coater and was passed through a drying zone at 50° C. for 3 minutes. Thereafter, irradiation with ultraviolet rays was performed under an atmosphere of nitrogen (integrating accumulate irradiation amount: about 600 mJ/cm²), curing with ultraviolet rays was performed, and the organic layer was wound up. The thickness of the organic layer formed on the support was 1 μm.

(Forming of Inorganic Layer)

Subsequently, an inorganic layer (silicon nitride layer) was formed on the surface of the organic layer by using a roll-to-roll CVD apparatus. Silane gas (flow rate: 160 sccm), ammonia gas (flow rate: 370 sccm), hydrogen gas (flow rate: 590 sccm), and nitrogen gas (flow rate: 240 sccm) were used as raw material gas. As a power source, a high-frequency power source with a frequency of 13.56 MHz was used. The film forming pressure was 40 Pa, and the film thickness reached was 50 nm. In this manner, the barrier film 10 in which the inorganic layer was laminated on the surface of the organic layer formed on the support was prepared.

A second organic layer was laminated on the surface of the inorganic layer. In the second organic layer, 5.0 parts by mass of a photopolymerization initiator (product name “IRGACURE 184”, manufactured by BASF SE) was weighed to 95.0 parts by mass of a urethane skeleton acrylate polymer (product name “ACRIT 8BR930”, manufactured by Taisei Fine Chemical Co., Ltd.) and was dissolved in methyl ethyl ketone to prepare a coating solution having a concentration of solid content of 15%.

This coating solution was directly applied to the surface of the inorganic layer by roll-to-roll using a die coater and passed through a drying zone at 100° C. for 3 minutes. Thereafter, the coating solution was cured by irradiation with ultraviolet rays (integrating accumulate irradiation amount of about 600 mJ/cm²) by being held by a heat roll heated to 60° C. and was wound up. The thickness of the second organic layer formed on the support was 1 μm. Accordingly, the barrier film 10 with the second organic layer was produced.

(Producing Barrier Film 11)

—Preparation of Polymerizable Composition for Forming Light Scattering Layer—

As light scattering particles, 150 g of silicone resin particles (product name “TOSPEARL 120”, manufactured by Momentive Performance Materials Inc., average particle size of 2.0 μm) and 40 g of polymethyl methacrylate (PMMA) particles (Techpolymer manufactured by Sekisui Chemical Co., Ltd., average particle size 8 μm) was first stirred with 550 g of methyl isobutyl ketone (MIBK) for about one hour and dispersed to obtain a dispersion. 50 g of an acrylate-based compound (VISCOAT 700HV manufactured by Osaka Organic Chemical Industry Ltd.) and 40 g of an acrylate-based compound (product name “8BR500”, manufactured by Taisei Fine Chemical Co., Ltd.) were added to the obtained dispersion liquid and further stirred. 1.5 g of a photopolymerization initiator (product name “IRGACURE (registered trademark) 819”, manufactured by BASF SE) and 0.5 g of a fluorine-based surfactant (product name “FC4430”, manufactured by 3M) were further added to prepare a coating solution (A polymerizable composition for forming a light scattering layer) was prepared.

—Application and Curing of Polymerizable Composition Forming Light Scattering Layer—

The coating solution was applied by a die coater such that the surface of the PET film of the barrier film 10 was the coated surface. The wet coating amount was adjusted with a liquid feed pump and the coating was performed at a coating amount of 25 cc/m² (the thickness was adjusted so as to be about 12 μm in the dry film). The film passed through a drying zone at 60° C. for three minutes, was wound around a backup roller adjusted at 30° C., cured with ultraviolet rays of 600 mJ/cm², and was wound up. Accordingly, the barrier film 11 in which the light scattering layer was laminated was obtained.

(Production of Barrier Film 12)

—Preparation of Polymerizable Composition for Forming Mat Layer—

190 g of silicone resin particles (product name: “TOSPEARL 2000b”, manufactured by Momentive Performance Materials Inc., average particle size 6.0 μm) were first stirred with 4,700 g of methyl ethyl ketone (MEK) for about one hour as particles to form unevenness of the mat layer and dispersed so as to obtain a dispersion liquid. 430 g of an acrylate-based compound (product name “A-DPH” Shin-Nakamura Chemical Co., Ltd.) and 800 g of an acrylate-based compound (product name “8BR930”, manufactured by Taisei Fine Chemical Co., Ltd.) were added to the obtained dispersion liquid and further stirred. 40 g of a photopolymerization initiator (product name “IRGACURE (registered trademark) 184”, manufactured by BASF SE) was added so as to produce a coating solution.

—Application and Curing of Polymerizable Composition for Forming Mat Layer—

The coating solution was applied by a die coater such that the surface of the PET film of the barrier film 10 was the coated surface. The wet coating amount was adjusted with a liquid feed pump and the coating was performed at a coating amount of 10 cc/m². The film passed through a drying zone at 80° C. for three minutes, was wound around a backup roller adjusted at 30° C., cured with ultraviolet rays of 600 ml/cm², and was wound up. The thickness of the mat layer formed after curing was about 3 to 6μ, and the mat layer had surface roughness in which the maximum section height Rt (measured based on JIS B0601) was 1 to 3 μm. Accordingly, a barrier film 12 in which an irregular layer was laminated was obtained.

(Preparation of Polymerizable Composition Used in Example 1 and Production of Coating Solution)

A polymerizable composition 1 below was prepared, was filtrated with a polypropylene filter having a pore size of 0.2 μm, and was dried under reduced pressure for 30 minutes, so as to be used as a coating solution.

-Polymerizable composition 1-

| | | |
|---|---|---|
| Toluene dispersion liquid (maximum emission | 20 | parts by mass |
| wavelength: 535 nm) of quantum dots 1 | | |
| Toluene dispersion liquid (maximum emission | 2 | parts by mass |
| wavelength: 630 nm) of quantum dots 2 | | |
| CELLOXIDE 2021P | 90 | parts by mass |
| Polymer dispersant: A-1 | 7 | parts by mass |
| Photoacid generator A | 2.3 | parts by mass |

As the toluene solution of the quantum dots 1 used in Example 1, a green quantum dot dispersion liquid having a maximum emission wavelength of 535 nm, CZ520-100 manufactured by NN-Labs, LLC. was used. As the toluene solution of the quantum dots 2, a red quantum dot dispersion liquid having a maximum emission wavelength of 630 nm, CZ620-100 manufactured by NN-Labs, LLC. was used. All of these were quantum dots using CdSe as a core, ZnS as a shell, and octadecylamine as a ligand and were dispersed in toluene at a concentration of 3 weight %.

Tables 1 to 5 present polymer dispersants of examples and comparative examples.

The solubility parameters (SP values) of these polymer dispersants were obtained by a calculation formula suggested by Toshinao Okitsu (Adhesion, Vol. 38, No. 6, page 10, 1994).

TABLE 1

| | | Coordinating | Polymer | SP value |
|---|---|---|---|---|
| Name | Structure | group | chain P | (MPa^{1/2}) |
| A-1 | 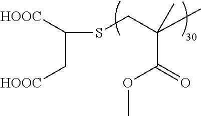 | COOH | 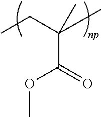 | 19.50 |
| A-2 | 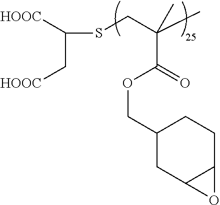 | COOH | 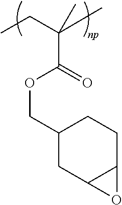 | 20.53 |
| A-3 | 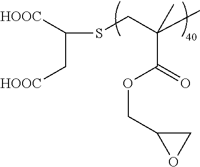 | COOH | 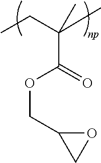 | 21.82 |

TABLE 2

| | | Coordinating | Polymer | SP value |
|---|---|---|---|---|
| Name | Structure | group | chain P | (MPa^{1/2}) |
| B-1 | 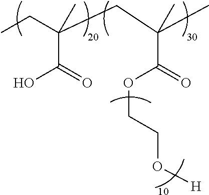 | COOH | 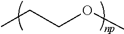 | 20.62 |
| B-2 | 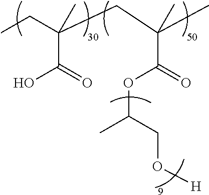 | COOH | 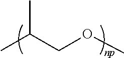 | 17.96 |
| B-3 | 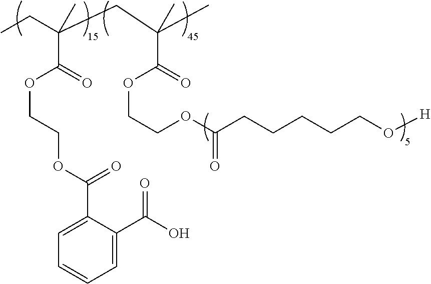 | COOH | 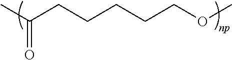 | 19.38 |
| B-4 | 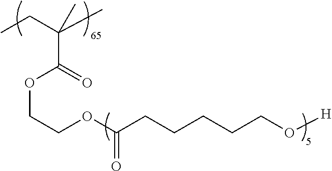 | — | 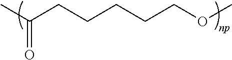 | 19.38 |

TABLE 3

| | | Coordinating | Polymer | SP value |
|---|---|---|---|---|
| Name | Structure | group | chain P | (MPa^{1/2}) |
| C-1 | 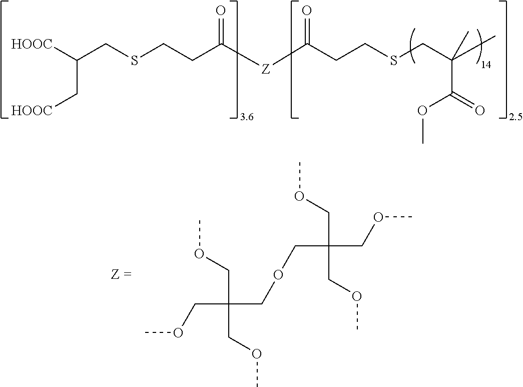 | COOH | 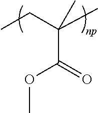 | 19.5 |
| C-2 | 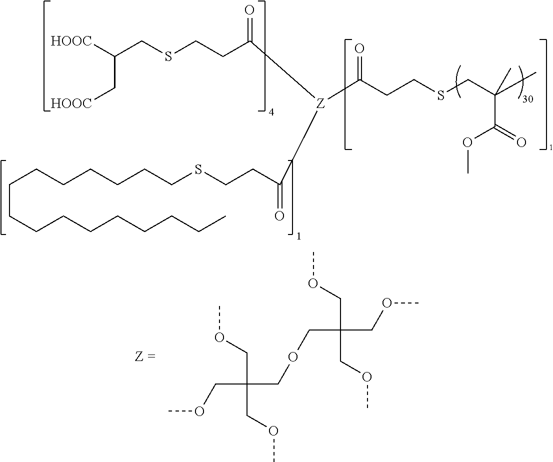 | COOH | 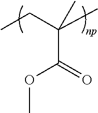 | 19.5 |
| C-3 | 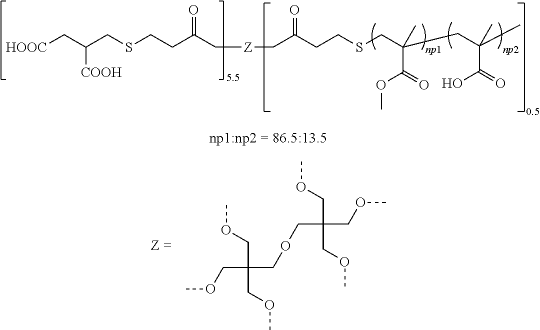 | COOH | 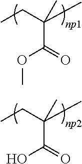 | 20.11 |

TABLE 4

| | | Coordinating | Polymer | SP value |
|---|---|---|---|---|
| Name | Structure | group | chain P | (MPa^{1/2}) |
| C-4 | 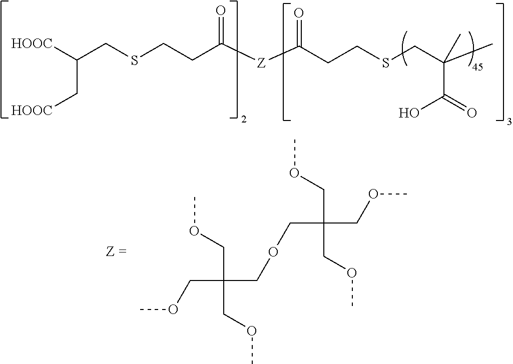 | COOH | 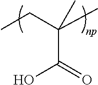 | 24.02 |
| C-5 | 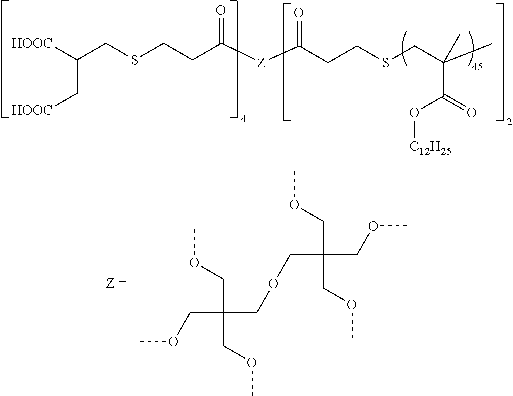 | COOH | 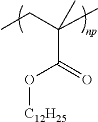 | 16.86 |
| C-6 | 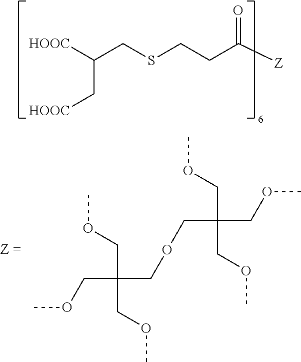 | COOH | — | — |
| C-7 | 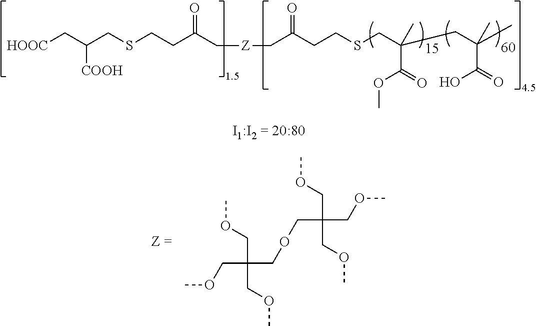 | | 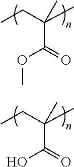 | 23.12 |

TABLE 5

| | | Coordinating | Polymer | SP value |
|---|---|---|---|---|
| Name | Structure | group | chain P | (MPa^{1/2}) |
| TOPO | 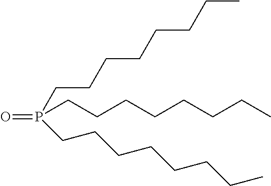 [SMILES: CCCCCCCCP(=O)(CCCCCCCC)CCCCCCCC] | Phosphine oxide | — | — |
| PSMA | 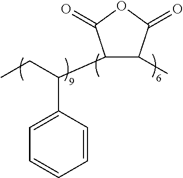 | — | — | — |
| PE-b-PEO | 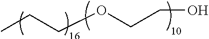 | — | — | 20.62 |

(Preparation of Polymerizable Compositions Used in Examples 2 and 3 and Production of Coating Solution)

Polymerizable compositions were produced in the same manner as in Example 1 except for using A-2 and A-3 respectively in the polymer dispersant and using Irgacure 290.

(Preparation of Polymerizable Compositions Used in Examples 4 to 6 and Production of Coating Solution)

Polymerizable compositions were produced in the same manner as in Example 1 except for using B-1 to B-3 in the polymer dispersant and using Irgacure 290.

(Preparation of Polymerizable Composition Used in Example 7 and Production of Coating Solution)

A polymerizable composition was produced in the same manner as in Example 1 except for using C-1 in the polymer dispersant.

(Preparation of Polymerizable Composition Used in Example 8 and Production of Coating Solution)

A polymerizable composition was produced in the same manner as in Example 7 except for using CYCLOMER M100 in the polymerizable compound.

(Preparation of Polymerizable Compositions Used in Examples 9 and 10 and Production of Coating Solution)

Polymerizable compositions were produced in the same manner as in Example 1 except for using C-2 and C-3 in the polymer dispersant and using 3 parts by mass of Irgacure 290.

(Preparation of Polymerizable Composition Used in Example 11 and Production of Coating Solution)

A polymerizable composition was produced in the same manner as in Example 7 except for adding VISCOAT #192 and further adding Irgacure 819 to the polymerizable compound.

(Preparation of Polymerizable Composition Used in Example 12 and Production of Coating Solution)

A polymerizable composition was produced in the same manner as in Example 7 except for adding TMPTA and further adding Irgacure 819 to the polymerizable compound.

(Preparation of Quantum Dot Containing Composition Used in Example 13 and Production of Coating Solution)

A quantum dot containing composition was produced in the same manner as in Example 7 except for using INP530-25 manufactured by NN-Labs, LLC. which is a green quantum dot dispersion liquid having a maximum emission wavelength of 530 nm as a toluene solution of the quantum dots 1, using INP620-25 manufactured by NN-Labs, LLC. which is a red quantum dot dispersion liquid having a maximum emission wavelength of 620 nm as a toluene solution of the quantum dots 2, and using Irgacure290.

Here, All of INP530-25 and INP620-25 manufactured by NN-Labs, LLC. were quantum dots using InP as a core, ZnS as a shell, and oleylamine as a ligand and were dispersed in toluene at a concentration of 3 weight %.

(Preparation of Polymerizable Composition Used in Comparative Example 1 and Production of Coating Solution)

A polymerizable composition was produced in the same manner as in Example 1 except for using trioctylphosphine oxide (TOPO) as a dispersing agent and using Irgacure 290.

(Preparation of Polymerizable Composition Used in Comparative Example 2 and Production of Coating Solution)

A polymerizable composition was produced in the same manner as in Example 1 except for using polyethylene-b-polyethylene oxide (PE-b-PEO) as a dispersing agent and using Irgacure 290.

(Preparation of Polymerizable Composition Used in Comparative Example 3 and Production of Coating Solution)

A polymerizable composition was produced in the same manner as in Example 1 except for using poly(styrene-co-maleic anhydride) (PSMA) as a dispersing agent and using 3 parts by mass of Irgacure 290.

(Preparation of Polymerizable Composition Used in Comparative Example 4 and Production of Coating Solution)

A polymerizable composition was produced in the same manner as in Example 1 except for using B-4 as a dispersing agent and using Irgacure 290.

(Preparation of Polymerizable Composition Used in Comparative Example 5 and Production of Coating Solution)

A polymerizable composition was produced in the same manner as in Example 1 except for using C-4 as a dispersing agent and using Irgacure 290.

(Preparation of Polymerizable Composition Used in Comparative Example 6 and Production of Coating Solution)

A polymerizable composition was produced in the same manner as in Example 1 except for using C-5 as a dispersing agent and using Irgacure 290.

(Preparation of Polymerizable Composition Used in Comparative Example 7 and Production of Coating Solution)

A polymerizable composition was produced in the same manner as in Example 1 except for using C-6 as a dispersing agent and using Irgacure 290.

(Preparation of Polymerizable Composition Used in Comparative Example 8 and Production of Coating Solution)

A polymerizable composition was produced in the same manner as in Example 1 except for using C-7 as a dispersing agent and using Irgacure 290.

(Preparation of Polymerizable Composition Used in Comparative Example 9 and Production of Coating Solution)

A polymerizable composition was produced in the same manner as in Example 1 except for using lauryl acrylate instead of CELLOXIDE 2021P in the monomer and using Irgacure 819 without using a dispersing agent.

(Production of Wavelength Conversion Member of Example 1)

The barrier film 11 produced in the procedure described above was used as the first film, and the barrier film 12 was used as the second film, and a wavelength conversion member was obtained in the manufacturing step described with reference to FIGS. 2 and 3. Specifically, the barrier film 11 was prepared as the first film and was continuously transported in the tension of 1 m/min and 60 N/m such that the surface side of the inorganic layer was coated with the quantum dot containing composition 1 with a die coater, so as to form a coating film having a thickness of 50 μm. Subsequently, the first film on which a coating film was formed was wound around the backup roller, the second film was laminated on the coating film in a direction in which the inorganic layer side was in contact with the coating film, and the coating film was cured by being irradiated with ultraviolet rays by using an air-cooled metal halide lamp (manufactured by Eye Graphics Co., Ltd.) of 160 W/cm while being continuously transported in a state in which the coating film was held between the barrier film 11 and the barrier film 12, so as to form the wavelength conversion layer containing quantum dots. The irradiation amount of the ultraviolet rays was 2,000 mJ/cm². L1 in FIG. 3 was 50 mm. L2 was 1 mm, and L3 was 50 mm.

(Production of Wavelength Conversion Members of Other Examples and Comparative Examples)

The wavelength conversion member was produced in the same manner as in Example 1 except for using coating solutions used in other examples and comparative examples.

Quantum dot dispersibility (indicating QD dispersibility in Table 6), initial brightness, and brightness durability of the wavelength conversion members produced as above were evaluated.

(Quantum Dot Dispersibility)

7 parts by mass of a dispersing agent were dissolved in 50 parts by mass of dichloromethane, and an arbitrary amount of quantum dots was dispersed. After 50 parts by mass of CELLOXIDE 2021P was added, dichloromethane was removed under reduced pressure to obtain an epoxy monomer dispersion liquid of quantum dots. The concentration of quantum dots in a case where suspension visually occurred was used as an indicator of quantum dot dispersibility. The measuring results are provided in Table 6.

<Evaluation Standard>

A: 1 wt % or greater

B: 0.5 wt % or greater and less than 1.0 wt %

C: 0.2 wt % or greater and less than 0.5 wt %

D: 0.1 wt % or greater and less than 0.2 wt %

E: Less than 0.1 wt %

(Measurement of Initial Brightness)

A commercially available tablet terminal equipped with a blue light source in the backlight unit (product name “Kindle (registered trademark) Fire HDX 7”, manufactured by Amazon.com, Inc., hereinafter simply referred to as Kindle Fire HDX 7) was disassembled, and a backlight unit was extracted. The wavelength conversion members of examples or comparative examples which were cut into a rectangle shape were incorporated instead of a quantum dot enhancement film (QDEF). In this manner, the liquid crystal display device was produced. The produced liquid crystal display device was turned on, the entire surface was caused to be white, and the brightness was measured by using a brightness meter (product name “SR3”, manufactured by TOPCON Technohouse Corporation) provided at a position of 520 mm in the vertical direction to the surface of the light guide plate. The brightness was evaluated based on the following evaluation standards. The measuring results are presented in Table 6.

<Evaluation Standard>

A: 10,000≦Y [cd/m²]

B: 9,000≦Y<10.000 [cd/m²]

C: 8,000≦Y<9,000 [cd/m²]

D: Y<8,000 [cd/m²]

(Brightness Durability)

The created wavelength conversion member was heated at 85° C. for 1,000 hours by using a precision thermostat DF411 manufactured by Yamato Scientific Co., Ltd. Thereafter, the brightness was measured by incorporating the wavelength conversion member to Kindle Fire HDX 7.

The heat resistance was evaluated based on the evaluation standard. The measuring results are presented in Table 6.

<Evaluation Standard>

A: Decrease in brightness after heating was less than 10%

B: Decrease in brightness after heating was 10% or greater and less than 20%

C: Decrease in brightness after heating was 20% or greater and less than 30%

D: Decrease in brightness after heating was 30% or greater

TABLE 6

| | | Composition for wavelength conversion layer | | | | |
|---|---|---|---|---|---|---|
| | | Wavelength | | | | |
| | | conversion | Toluene dispersion | Toluene dispersion | | |
| | | layer film | liquid of | liquid of | Polymerizable | Polymerizable |
| | Base material | thickness | quantum dots 1 | quantum dots 2 | compound | compound |
| | film | (μm) | (parts by mass) | (parts by mass) | (parts by mass) | (parts by mass) |
| Example 1 | Barrier films | 50 | (20) | (2) | CELLOXIDE 2021P | |
| | 11 and 12 | | | | (90) | |
| Example 2 | Barrier films | 50 | (20) | (2) | CELLOXIDE 2021P | |
| | 11 and 12 | | | | (90) | |
| Example 3 | Barrier films | 50 | (20) | (2) | CELLOXIDE 2021P | |
| | 11 and 12 | | | | (90) | |
| Example 4 | Barrier films | 50 | (20) | (2) | CELLOXIDE 2021P | |
| | 11 and 12 | | | | (90) | |
| Example 5 | Barrier films | 50 | (20) | (2) | CELLOXIDE 2021P | |
| | 11 and 12 | | | | (90) | |
| Example 6 | Barrier films | 50 | (20) | (2) | CELLOXIDE 2021P | |
| | 11 and 12 | | | | (90) | |
| Example 7 | Barrier films | 50 | (20) | (2) | CELLOXIDE 2021P | |
| | 11 and 12 | | | | (90) | |
| Example 8 | Barrier films | 50 | (20) | (2) | CYCLOMER M100 | |
| | 11 and 12 | | | | (90) | |
| Example 9 | Barrier films | 50 | (20) | (2) | CELLOXIDE 2021P | |
| | 11 and 12 | | | | (90) | |
| Example 10 | Barrier films | 50 | (20) | (2) | CELLOXIDE 2021P | |
| | 11 and 12 | | | | (90) | |
| Example 11 | Barrier films | 50 | (20) | (2) | CELLOXIDE 2021P | VISCOAT #192 (40) |
| | 11 and 12 | | | | (50) | |
| Example 12 | Barrier films | 50 | (20) | (2) | CELLOXIDE 2021P | A-TMPT |
| | 11 and 12 | | | | (70) | (20) |
| Example 13 | Barrier films | 50 | (20) | (2) | CELLOXIDE 2021P | |
| | 11 and 12 | | | | (90) | |
| Comparative | Barrier films | 50 | (20) | (2) | CELLOXIDE 2021P | |
| Example 1 | 11 and 12 | | | | (90) | |
| Comparative | Barrier films | 50 | (20) | (2) | CELLOXIDE 2021P | |
| Example 2 | 11 and 12 | | | | (90) | |
| Comparative | Barrier films | 50 | (20) | (2) | CELLOXIDE 2021P | |
| Example 3 | 11 and 12 | | | | (90) | |
| Comparative | Barrier films | 50 | (20) | (2) | CELLOXIDE 2021P | |
| Example 4 | 11 and 12 | | | | (90) | |
| Comparative | Barrier films | 50 | (20) | (2) | CELLOXIDE 2021P | |
| Example 5 | 11 and 12 | | | | (90) | |
| Comparative | Barrier films | 50 | (20) | (2) | CELLOXIDE 2021P | |
| Example 6 | 11 and 12 | | | | (90) | |
| Comparative | Barrier films | 50 | (20) | (2) | CELLOXIDE 2021P | |
| Example 7 | 11 and 12 | | | | (90) | |
| Comparative | Barrier films | 50 | (20) | (2) | CELLOXIDE 2021P | |
| Example 8 | 11 and 12 | | | | (90) | |
| Comparative | Barrier films | 50 | (20) | (2) | Lauryl acrylate | |
| Example 9 | 11 and 12 | | | | (97) | |

| | Composition for wavelength conversion layer | | | | | | |
|---|---|---|---|---|---|---|---|
| | Dispersant | | | | | | |
| | | | | Photo radical | Evaluation result | | |
| | Material | SP value | Photoacid generator | generator | QD | Initial | Brightness |
| | (parts by mass) | (MPa^{1/2}) | (parts by mass) | (parts by mass) | dispersibility | brightness | durability |
| Example 1 | A-1 | 19.50 | Photoacid generator | | B | A | B |
| | (7) | | A (2.3) | | | | |
| Example 2 | A-2 | 20.53 | Irgacure 290 | | B | A | B |
| | (7) | | (2.3) | | | | |
| Example 3 | A-3 | 21.82 | Irgacure 290 | | B | A | B |
| | (7) | | (2.3) | | | | |
| Example 4 | B-1 | 20.62 | Irgacure 290 | | B | B | B |
| | (7) | | (2.3) | | | | |
| Example 5 | B-2 | 17.96 | Irgacure 290 | | A | B | A |
| | (7) | | (2.3) | | | | |
| Example 6 | B-3 | 19.38 | Irgacure 290 | | A | B | A |
| | (7) | | (2.3) | | | | |
| Example 7 | C-1 | 19.50 | Photoacid generator | | A | A | A |
| | (7) | | A (2.3) | | | | |
| Example 8 | C-1 | 19.50 | Photoacid generator | | A | A | A |
| | (7) | | A (2.3) | | | | |
| Example 9 | C-2 | 19.5 | Irgacure 290 | | A | A | A |
| | (7) | | (3) | | | | |
| Example 10 | C-3 | 20.11 | Irgacure 290 | | A | B | A |
| | (7) | | (3) | | | | |
| Example 11 | C-1 | 19.50 | Photoacid generator | Irgacure819 | B | B | B |
| | (7) | | A (1.3) | (1) | | | |
| Example 12 | C-1 | 19.50 | Photoacid generator | Irgacure819 | A | B | B |
| | (7) | | A (1.6) | (0.7) | | | |
| Example 13 | C-1 | 19.50 | Irgacure 290 | | A | B | B |
| | (7) | | (2.3) | | | | |
| Comparative | TOPO | — | Irgacure 290 | | E | B | C |
| Example 1 | (7) | | (2.3) | | | | |
| Comparative | PE-b-PEO | 20.62 | Irgacure 290 | | D | B | B |
| Example 2 | (7) | | (2.3) | | | | |
| Comparative | PSMA | — | Irgacure 290 | | D | C | B |
| Example 3 | (7) | | (3) | | | | |
| Comparative | B-4 | 19.38 | Irgacure 290 | | D | B | B |
| Example 4 | (7) | | (2.3) | | | | |
| Comparative | C-4 | 24.02 | Irgacure 290 | | E | C | B |
| Example 5 | (7) | | (2.3) | | | | |
| Comparative | C-5 | 16.86 | Irgacure 290 | | E | B | B |
| Example 6 | (7) | | (2.3) | | | | |
| Comparative | C-6 | — | Irgacure 290 | | E | C | B |
| Example 7 | (7) | | (2.3) | | | | |
| Comparative | C-7 | 23.12 | Irgacure 290 | | E | C | B |
| Example 8 | (7) | | (2.3) | | | | |
| Comparative | — | — | | Irgacure 819 | A | A | D |
| Example 9 | | | | (2.3) | | | |

Hereinafter, details of Table 6 are provided.

CELLOXIDE 2021P: Alicyclic epoxy monomer, manufactured by Daicel Corporation

CYCLOMER M100: Alicyclic epoxy monomer, manufactured by Daicel Corporation

VISCOAT #192 (Phenoxyethyl acrylate): manufactured by Osaka Organic Chemical Industry Co., Ltd.

A-TMPT (Trimethylolpropane triacrylate): manufactured by Daicel-Allnex Ltd.)

Lauryl acrylate: manufactured by Tokyo Chemical Industry Co., Ltd. (TCI)

TOPO: Trioctylphosphine oxide, manufactured by Tokyo Chemical Industry Co., Ltd. (TCI)

Poly(styrene-co-maleic anhydride) (PSMA): Sigma-Aldrich Co. LLC.

PE-b-PEO: Polyethylene-b-polyethylene oxide, Sigma-Aldrich Co. LLC.

Photoacid generator (iodonium salt compound) A

Irgacure 290: Photoacid generator, manufactured by BASF SE

Irgacure 819: Photo radical generator, manufactured by BASF SE

As presented in Table 6, Examples 1 to 13 in which the polymerizable composition according to the present invention was used were able to obtain the evaluation of B or greater in all of quantum dot dispersibility, initial brightness, and brightness durability.

Meanwhile, quantum dot dispersibility was deteriorated in all of Comparative Examples 1 to 8. Particularly, Comparative Example 3 not having a coordinating group had deteriorated initial brightness. It is assumed that, in Comparative Example 5, 7, and 8 not having the polymer chain according to the present invention, initial brightness was low due the aggregation of quantum dots. Comparative Example 9 in which a dispersing agent was not contained and lauryl acrylate not having an epoxy group or an oxetanyl group was used had deteriorated brightness durability.

### EXPLANATION OF REFERENCES

1A: light source
1B: light guide plate
1C: surface light source
1D: wavelength conversion member
2: backlight unit
2A: reflecting plate
2B: retroreflecting member
3: liquid crystal cell unit
4: liquid crystal display device
10,20: barrier film
11,21: support
12,22: barrier layer
12a,22a: organic layer
12b,22b: inorganic layer
13: unevenness imparting layer (mat layer)
30: wavelength conversion layer
30A, 30B: quantum dot
30P: organic matrix
31: liquid crystal cell
L_{B}: excitation light (primary light, blue light)
L_{R}: red light (secondary light, fluorescence)
L_{G}: green light (secondary light, fluorescence)
L_{W}: white light

What is claimed is:

1. A polymerizable composition comprising:
a quantum dot;
a monomer having an epoxy group or an oxetanyl group; and
a polymer dispersant,
wherein the polymer dispersant is a compound represented by Formula I, 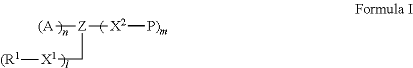
in Formula I, A is an organic group having a coordinating group coordinated with the quantum dot, Z is an (n+m+l)-valent organic linking group, X¹ and X² are a single bond or a divalent organic linking group, R¹ represents an alkyl group, an alkenyl group, or an alkynyl group each of which may have a substituent, P is a polymer chain which has a polymerization degree of 3 or greater and which includes at least one polymer skeleton selected from a polyacrylate skeleton, a polymethacrylate skeleton, a polyacrylamide skeleton, a polymethacrylamide skeleton, a polyester skeleton, a polyurethane skeleton, a polyurea skeleton, a polyamide skeleton, a polyether skeleton, a polyvinyl ether skeleton, and a polystyrene skeleton and of which a solubility parameter is 17 MPa^{1/2} to 22 MPa^{1/2}, n and m are each independently the number of 1 or greater, l is the number of 0 or greater, n+m+l is an integer of 2 to 10, n items of A's may be identical to or different from each other, m items of P's may be identical to or different from each other, and 1 items of X¹'s and R¹'s may be identical to or different from each other.

2. The polymerizable composition according to claim 1,
wherein the polymer chain P is represented by Formula P1, 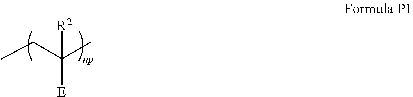
in Formula P1, E is a substituent including at least one of —O—, —CO—, —COO—, —COOR^{y}, an epoxy group, an oxetanyl group, an alicyclic epoxy group, an alkylene group, an alkyl group, or an alkenyl group, R^{y} is a hydrogen atom or an alkyl group having 1 to 6 carbon atoms, R² is a hydrogen atom or an alkyl group having 1 to 6 carbon atoms, np is the number of 3 to 500, and a plurality of E's and R²'s may be identical to or different from each other.

3. The polymerizable composition according to claim 2,
wherein n and m are 1, l is 0, and the polymer dispersant is represented by Formula II.

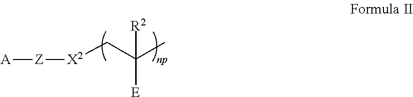

4. The polymerizable composition according to claim 1,
wherein A is represented by Formula A1, 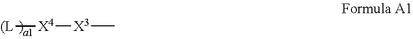
in Formula A1, X³ is a single bond or a divalent organic linking group, X⁴ is an (a1+1)-valent organic linking group, L is the coordinating group, a1 is an integer of 1 to 2.

5. The polymerizable composition according to claim 1, wherein, in Formula I, Z is a group selected from the group consisting of organic linking groups represented by the following Formulae (1) to (20): 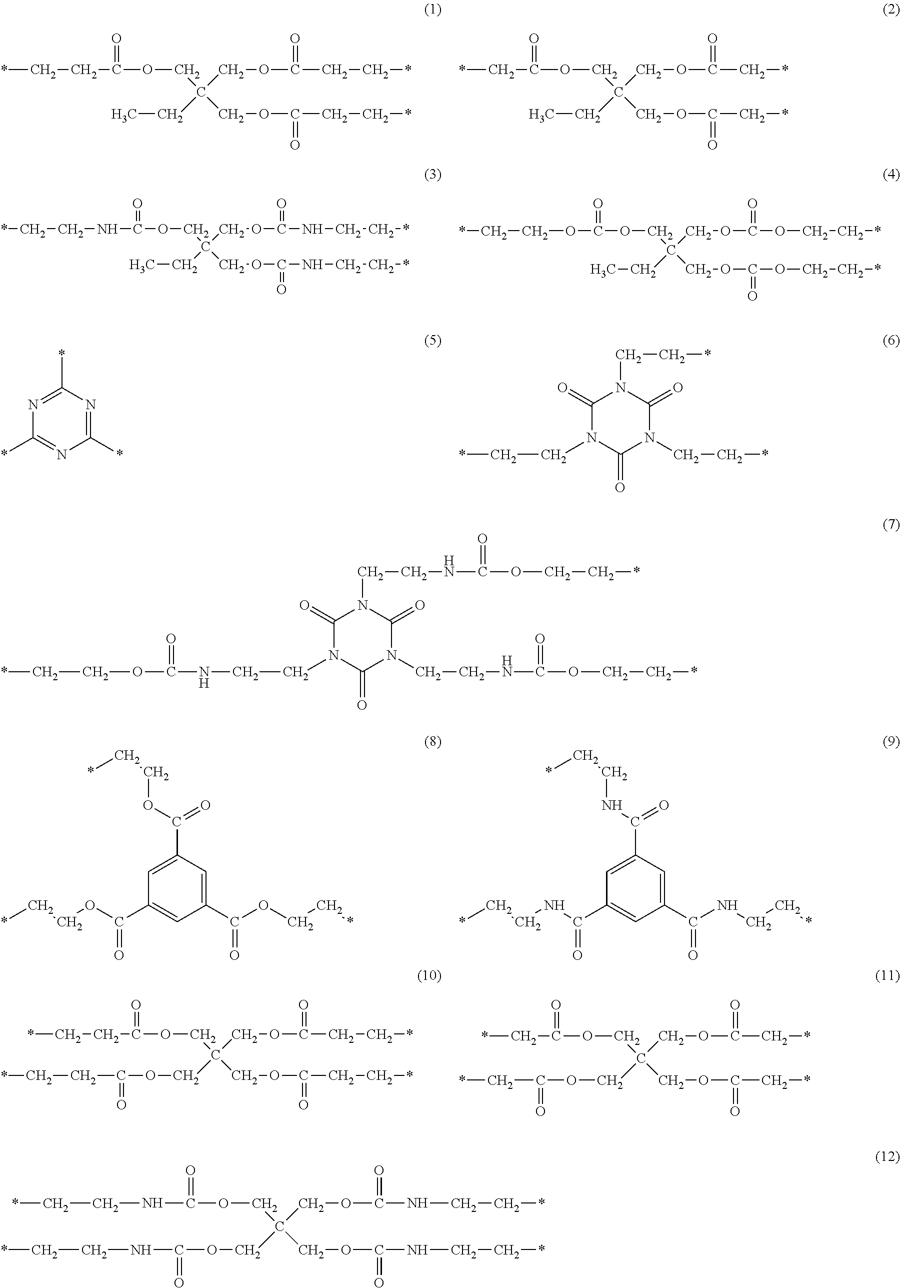 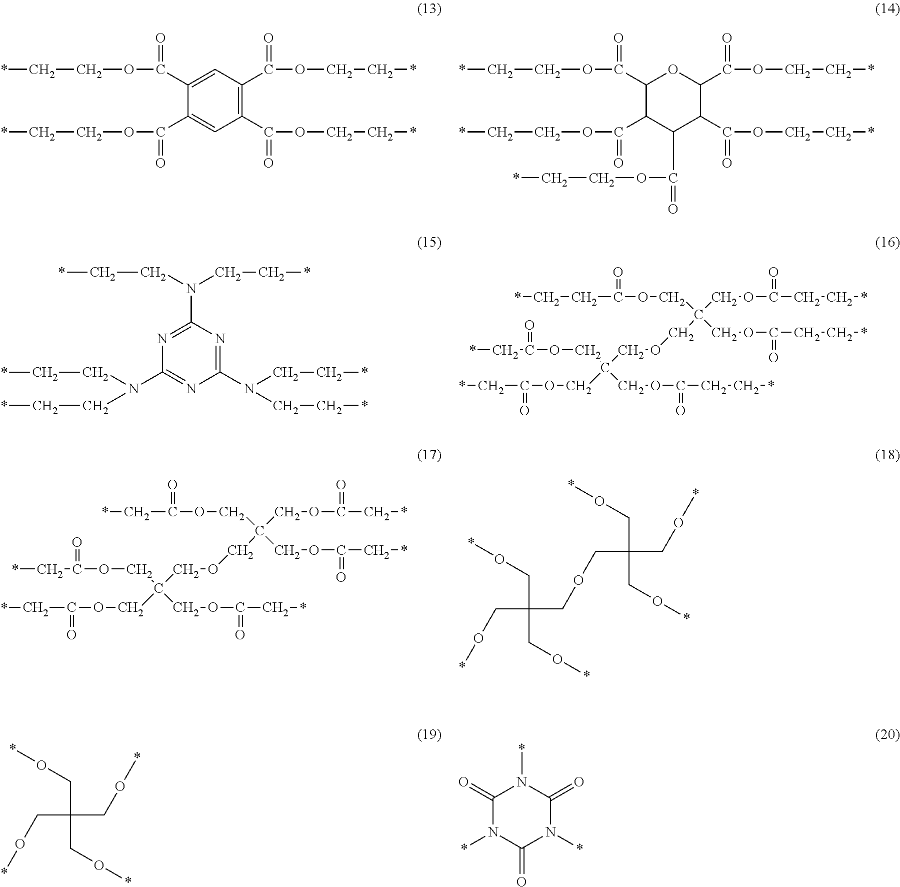
wherein, in the organic linking groups, * indicates a position that is bonded to A, X¹, and X² in Formula I.

6. The polymerizable composition according to claim 4, wherein, in Formula A1, a group comprising the coordinating group L and the (a1+1)-valent organic linking group X⁴ is a group selected from groups represented by the following Formulae: 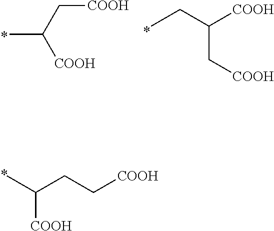
wherein, in the groups, * indicates a position that is bonded to X³ in Formula A1.

7. A polymerizable composition comprising:
a quantum dot;
a monomer having an epoxy group or an oxetanyl group; and
a polymer dispersant,
wherein the polymer dispersant is a compound represented by Formula III, 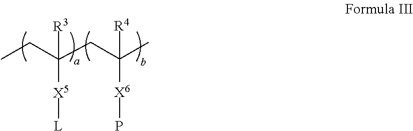
in Formula III, X⁵ and X⁶ are a single bond or a divalent organic linking group, R³ and R⁴ are a hydrogen atom or an alkyl group having 1 to 6 carbon atoms, L is a coordinating group coordinated with the quantum dot, P is a polymer chain which has a polymerization degree of 3 or greater and which includes at least one polymer skeleton selected from a polyacrylate skeleton, a polymethacrylate skeleton, a polyacrylamide skeleton, a polymethacrylamide skeleton, a polyester skeleton, a polyurethane skeleton, a polyurea skeleton, a polyamide skeleton, a polyether skeleton, a polyvinyl ether skeleton, and a polystyrene skeleton and of which a solubility parameter is 17 MPa^{1/2} to 22 MPa^{1/2}, a and b are each independently the number of 1 or greater, a+b is 2 to 1,000, a plurality of L's may be identical to or different from each other, and a plurality of P's may be identical to or different from each other.

8. The polymerizable composition according to claim 1,
wherein the coordinating group is at least one selected from an amino group, a carboxy group, a mercapto group, a phosphine group, and a phosphine oxide group.

9. The polymerizable composition according to claim 1,
wherein the monomer is an alicyclic epoxy compound.

10. The polymerizable composition according to claim 1, further comprising:
a photopolymerization initiator.

11. The polymerizable composition according to claim 5, further comprising a photopolymerization initiator, wherein the coordinating group is at least one selected from an amino group, a carboxy group, a mercapto group, a phosphine group or a phosphine oxide group, and the monomer is an alicyclic epoxy compound.

12. The polymerizable composition according to claim 7, further comprising a photopolymerization initiator, wherein the coordinating group is at least one selected from an amino group, a carboxy group, a mercapto group, a phosphine group or a phosphine oxide group, and the monomer is an alicyclic epoxy compound.

13. The polymerizable composition according to claim 1,
wherein the quantum dot is at least one kind selected from a quantum dot having a center emission wavelength in a wavelength range of 600 nm to 680 nm, a quantum dot having a center emission wavelength in a wavelength range of 520 nm to 560 nm, and a quantum dot having a center emission wavelength in a wavelength range of 430 nm to 480 nm.

14. The polymerizable composition according to claim 7,
wherein the quantum dot is at least one kind selected from a quantum dot having a center emission wavelength in a wavelength range of 600 nm to 680 nm, a quantum dot having a center emission wavelength in a wavelength range of 520 nm to 560 nm, and a quantum dot having a center emission wavelength in a wavelength range of 430 nm to 480 nm.

15. The polymerizable composition according to claim 11,
wherein the quantum dot is at least one kind selected from a quantum dot having a center emission wavelength in a wavelength range of 600 nm to 680 nm, a quantum dot having a center emission wavelength in a wavelength range of 520 nm to 560 nm, and a quantum dot having a center emission wavelength in a wavelength range of 430 nm to 480 nm.

16. A wavelength conversion member comprising:
a wavelength conversion layer obtained by curing the polymerizable composition according to claim 1.

17. The wavelength conversion member according to claim 16, further comprising:
a barrier film having an oxygen permeability of 1.00 cm³/(m²·day·atm) or less,
wherein at least one of two main surfaces of the wavelength conversion layer is in contact with the barrier film.

18. The wavelength conversion member according to claim 17,
wherein two of the barrier films are provided, and
wherein each of the two main surfaces of the wavelength conversion layer is in contact with the barrier film.

19. A backlight unit comprising, at least:
the wavelength conversion member according to claim 16; and
a light source.

20. A liquid crystal display device comprising, at least:
the backlight unit according to claim 19; and
a liquid crystal cell.
